(19) United States
(12) Patent Application Publication
(10) Pub. No.: US 2017/0084373 A1
(43) Pub. Date: Mar. 23, 2017

(54) PROGRAMMABLE MAGNET ORIENTATIONS IN A MAGNETIC ARRAY

(71) Applicant: QUALCOMM Incorporated, San Diego, CA (US)

(72) Inventor: John Hyunchul Hong, San Clemente, CA (US)

(21) Appl. No.: 14/860,223

(22) Filed: Sep. 21, 2015

(51) Int. Cl. H01F 7/02; H01F 41/02

(52) U.S. Cl. CPC H01F 7/0278; H01F 41/026

(57) ABSTRACT

This disclosure provides methods and apparatus for adjusting magnetic orientations of different sets of magnets in an array. In one aspect, a first set of magnets in the array can be heated. A magnetic field with a first orientation can be applied to the array of the magnets, and adjusting the magnetic orientations of the first set of magnets to the first orientation of the magnetic field. A second set of magnets in the array can be heated and the magnetic field can have a second orientation. The magnetic orientations of the second set of magnets can be adjusted to the second orientation.

### FIELD

The present disclosure relates generally to electromechanical systems and devices, and more specifically, to programmable magnet orientations in a magnetic array that can be used in a wireless power transmission system.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections through cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices or provide power to electronic devices may overcome some of the deficiencies of wired charging solutions. As such, methods and apparatuses for wireless power transmission are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One innovative aspect of the subject matter in this disclosure can be implemented in a method for adjusting magnetic orientations of different sets of magnets in an array, the array including a first set of magnets and a second set of magnets. The method can include heating the first set of magnets in the array; applying a first magnetic field with a first orientation to the array of magnets; adjusting the magnetic orientations of the first set of magnets in the array to correspond with the first orientation of the first magnetic field based on the heating of the first set of magnets and the applied first magnetic field with the first orientation; heating the second set of magnets in the array; applying a second magnetic field with a second orientation to the array of magnets; and adjusting the magnetic orientations of the second set of magnets in the array to correspond with the second orientation of the second magnetic field based on the heating of the second set of magnets in the array and the applied second magnetic field with the second orientation.

In some implementations, the method includes heating the first set of magnets heats magnetic material of the first set of magnets to a first temperature range, magnetic material of the second set of magnets being at a second temperature range, the first temperature range corresponding to temperatures at or above a curie temperature of the magnetic material of the first set of magnets, the second temperature range corresponding to temperatures below the curie temperature of the magnetic material of the second set of magnets.

In some implementations, the curie temperature corresponds to a temperature in which the magnetic material of the first set of magnets is susceptible to be oriented in a direction of the first magnetic field with the first orientation in response to applying the first magnetic field.

In some implementations, the magnetic material of the second set of magnets are not susceptible be oriented in the direction of the first magnetic field in response to applying the first magnetic field with the first orientation.

In some implementations, applying the first magnetic field with the first orientation comprises having a magnetic field strength of the first magnetic field capable of adjusting the magnetic orientations of magnetic material of the first set of the magnets with the first orientation, and incapable of adjusting the magnetic orientations of magnetic material of the second set of magnets with the first orientation.

In some implementations, the first orientation and the second orientation are different.

In some implementations, heating the first set of magnets forms thermal barriers in the first set of magnets.

In some implementations, the thermal barriers can allow the first set of magnets to reach or exceed a curie temperature of magnetic material of the first set of magnets.

In some implementations, the thermal barriers can be air gaps.

In some implementations, the method includes etching free spaces to allow for the magnets in the array to oscillate into the free spaces.

In some implementations, each of the magnets can be part of a corresponding structure implementing a resonant mechanical oscillator configured to oscillate at a frequency of an externally generated magnetic field.

Another innovative aspect of the subject matter described in this disclosure can be implemented in an array of magnets on a substrate, each of the magnets comprising a silicide layer having a portion within the substrate; a thermal barrier layer adjacent to the silicide layer; an oxide layer adjacent to the thermal barrier layer opposite the silicide layer; and a magnetic material layer adjacent to the oxide layer opposite the thermal barrier layer.

In some implementations, the array can include a first magnet and a second magnet, the first magnet having the magnetic material corresponding to a first magnetic orientation, the second magnet having the magnetic material corresponding to a second magnetic orientation, the first magnetic orientation and the second magnetic orientation being different.

In some implementations, the orientations of the first magnetic orientation and the second magnetic orientation can be opposed to each other.

In some implementations, each of the magnets can include an anti-reflective coating (ARC) layer deposited on the magnetic material layer.

In some implementations, the thermal barrier layer can be an air gap.

Another innovative aspect of the subject matter described in this disclosure can be implemented in a method for forming a thermal barrier in a magnetic device, the method comprising absorbing energy from an energy source; raising a temperature of magnetic material of the magnetic device to a first temperature responsive to the absorbing of the energy; forming a thermal barrier in the magnetic device responsive to the magnetic material being raised to the first temperature; and raising the temperature of the magnetic material of the magnetic device to a second temperature responsive to the forming of the thermal barrier.

In some implementations, the second temperature can be higher than the first temperature.

In some implementations, the thermal barrier can be an air gap.

In some implementations, forming the thermal barrier can comprise forming a silicide layer into a substrate from a diffusion of a metal layer deposited upon the substrate.

In some implementations, the thermal barriers can be air gaps formed between an oxide layer and the silicide layer.

In some implementations, the silicide layer can be formed responsive to raising the temperature of the magnetic material of the magnetic device to the first temperature.

In some implementations, the second temperature can be at or exceed a curie temperature of the magnetic material.

Another innovative aspect of the subject matter described in this disclosure can be implemented in an array of magnets on a substrate, each of the magnets comprising means for absorbing energy to raise a temperature of magnetic material of the magnet to a first temperature; means for providing a thermal barrier in the magnet responsive to the magnetic material being raised to the first temperature; and means for absorbing energy to raise the temperature of the magnetic material of the magnet to a second temperature responsive to the providing of the thermal barrier.

### BRIEF DESCRIPTION OF THE DRAWINGS

FIG. 1 is a functional block diagram of a wireless power transfer system, in accordance with some exemplary implementations.

FIG. 2 is a functional block diagram of components that may be used in the wireless power transfer system of FIG. 1, in accordance with some exemplary implementations.

FIG. 3 is a schematic diagram of a portion of transmit circuitry or receive circuitry of FIG. 2 including a transmit or receive coupler.

FIG. 4 is a functional block diagram of a transmitter that may be used in the wireless power transfer system of FIG. 1, in accordance with some exemplary implementations.

FIG. 5 is a functional block diagram of a receiver that may be used in the wireless power transfer system of FIG. 1, in accordance with some exemplary implementations.

FIG. 6 is a schematic diagram of a portion of transmit circuitry that may be used in the transmitter of FIG. 4.

FIG. 7 illustrates non-radiative inductive power transfer based on Faraday's law using capacitively loaded wire loops at both the transmit and receive sides.

FIG. 8 schematically illustrates an example magneto-mechanical oscillator, in accordance with some exemplary implementations.

FIG. 9 schematically illustrates an example magneto-mechanical oscillator (e.g., a portion of a plurality of magneto-mechanical oscillators) with a coupling coil wound around (e.g., surrounding) the magneto-mechanical oscillator, in accordance with some exemplary implementations.

FIG. 10A schematically illustrates the parallel magnetic flux lines (B) inside a magnetized sphere.

FIG. 10B schematically illustrates the magnetic field strength (H) in a magnetized sphere.

FIG. 11 schematically illustrates an example array of magneto-mechanical oscillators, in accordance with some exemplary implementations.

FIG. 12 schematically illustrates a cut through area of a three-dimensional array of magneto-mechanical oscillators, in accordance with some exemplary implementations.

FIG. 13 schematically illustrates an example coupling coil wound around a disk having a plurality of magneto-mechanical oscillators, in accordance with some exemplary implementations.

FIG. 14 schematically illustrates an example power transmitter configured to wirelessly transfer power to at least one power receiver, in accordance with some exemplary implementations.

FIG. 15 schematically illustrates an example power transmitter, in accordance with some exemplary implementations, and a plot of input impedance versus frequency showing a resonance phenomenon.

FIG. 16 schematically illustrates a portion of a configuration of a plurality of magneto-mechanical oscillators, in accordance with some exemplary implementations.

FIG. 17 schematically illustrates a configuration of the plurality of magneto-mechanical oscillators in which magnetic elements are pairwise oriented in opposite directions so that the static component of the sum magnetic moment cancels out, in accordance with some exemplary implementations.

FIG. 18A illustrates non-uniform magnetic orientations of magnetic devices following a deposition of magnetic material, in accordance with some exemplary implementations.

FIG. 18B illustrates uniform magnetic orientations of magnetic devices, in accordance with some exemplary implementations.

FIG. 18C illustrates alternating magnetic orientations of magnetic devices, in accordance with some exemplary implementations.

FIG. 19A illustrates a cross-section of a magnetic device, in accordance with some exemplary implementations.

FIG. 19B illustrates a cross-section of a magnetic device with a thermal barrier, in accordance with some exemplary implementations.

FIG. 20 illustrates heating different subsets of magnetic devices in an array, in accordance with some exemplary implementations.

FIG. 21 is a flowchart of a method of adjusting magnetic orientations of different subsets of magnetic devices in an array, in accordance with some exemplary implementations

FIGS. 22A-F illustrate adjusting magnetic orientations of different subsets of magnetic devices in an array, in accordance with some exemplary implementations.

FIG. 23 is a flowchart of a method of forming a thermal barrier in a magnetic device, in accordance with some exemplary implementations.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Devices such as magneto-mechanical oscillators in an array can be used in a receiver of a wireless power system to convert magnetic energy provided by a transceiver to mechanical energy to electrical energy to power a load. Each of the magneto-mechanical oscillators can include corresponding magnetic material used to aid the oscillation of the magneto-mechanical oscillators in response to an applied magnetic field providing the magnetic energy. When placed (or deposited), the magnetic material in the array can initially have relatively random orientations for their magnetic moments.

Some implementations of the subject matter described in this disclosure can “program” the magnetic material to have particular magnetic orientations (for the magnetic moments) so that the magneto-mechanical oscillators can efficiently interact with the applied magnetic field. For example, the magnetic material of the magneto-mechanical oscillators in the array can be programmed to have alternating magnetic orientations. Different subsets of the magnetic material can be programmed separately by heating the different subsets at different times (or phases, operations, etc.) and applying a magnetic field (during the manufacturing process) during the different times with the desired magnetic orientations for the magnetic material. If the magnetic material of one subset is heated to a high enough temperature (corresponding to its Curie point) but the magnetic material of a second subset is not heated to a high enough temperature, then the magnetic material of the first subset can be programmed to have their magnetic orientations to be similar to the orientation of an applied magnetic field while the magnetic orientations of the magnetic material of the second subset is unchanged. The second subset can then be heated while the first subset is not such that the magnetic material of the second subset is then programmed while the magnetic material of the first subset is unchanged (i.e., keep the orientation of the magnetic field that was applied when they were heated). In some implementations, air gaps can be formed during the heating to provide thermal barriers to allow for the magnetic material to reach a high enough temperature to be susceptible to the applied magnetic field.

Particular implementations of the subject matter described in this disclosure can be implemented to realize one or more of the following potential advantages. Implementing an array of devices (e.g., magneto-mechanical oscillators) with alternating magnetic orientations can reduce the strong magnetization that may result from the array of devices including the magnetic material, and therefore, reduces the likelihood of other magnetic materials being attracted into the vicinity of or towards the array.

The detailed description set forth below in connection with the appended drawings is intended as a description of exemplary implementations of the invention and is not intended to represent the only implementations in which the invention may be practiced. The term “exemplary” used throughout this description means “serving as an example, instance, or illustration,” and should not necessarily be construed as preferred or advantageous over other exemplary implementations. The detailed description includes specific details for the purpose of providing a thorough understanding of the exemplary implementations of the invention. In some instances, some devices are shown in block diagram form.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a receiver to achieve power transfer.

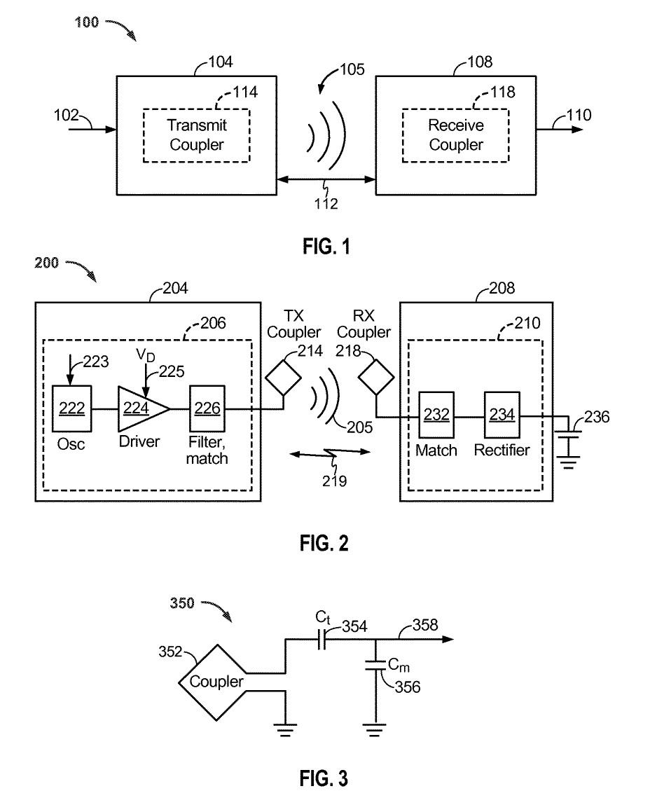

FIG. 1 is a functional block diagram of a wireless power transfer system 100, in accordance with some exemplary implementations. Input power 102 may be provided to a transmitter 104 from a power source (not shown) to generate a wireless (e.g., magnetic or electromagnetic) field 105 via a transmit coupler 114 for performing energy transfer. The receiver 108 may receive power when the receiver 108 is located in the wireless field 105 produced by the transmitter 104. The wireless field 105 corresponds to a region where energy output by the transmitter 104 may be captured by the receiver 108. A receiver 108 including a receive coupler 118 may couple to the wireless field 105 and generate output power 110 for storing or consumption by a device (not shown in this figure) coupled to the output power 110. Both the transmitter 104 and the receiver 108 are separated by a distance 112.

In one example implementation, power is transferred inductively via a time-varying magnetic field generated by the transmit coupler 114. The transmitter 104 and the receiver 108 may further be configured according to a mutual resonant relationship. When the resonant frequency of the receiver 108 and the resonant frequency of the transmitter 104 are substantially the same or very close, transmission losses between the transmitter 104 and the receiver 108 are reduced. However, even when resonance between the transmitter 104 and receiver 108 are not matched, energy may be transferred, although the efficiency may be reduced. For example, the efficiency may be less when resonance is not matched. Transfer of energy occurs by coupling energy from the wireless field 105 of the transmit coupler 114 to the receive coupler 118, residing in the vicinity of the wireless field 105, rather than propagating the energy from the transmit coupler 114 into free space.

Resonant coupling techniques may thus allow for improved efficiency and power transfer over various distances and with a variety of magneto-mechanical oscillator coupler configurations.

The receiver 108 may receive power when the receiver 108 is located in the wireless field 105 produced by the transmitter 104. The wireless field 105 corresponds to a region where energy output by the transmitter 104 may be captured by the receiver 108. The wireless field 105 may correspond to the “near-field” of the transmitter 104. The near-field may correspond to a region in which there are strong reactive fields resulting from the magnetic and/or electromagnetic fields generated by the transmit coupler 114 that minimally radiate power away from the transmit coupler 114. The near-field may correspond to a region that is within about one wavelength (or a fraction thereof) of the fundamental frequency at which the transmit coupler 114 operates.

FIG. 2 is a functional block diagram of a wireless power transfer system 200, in accordance with some other exemplary implementations. The system 200 may be a wireless power transfer system of similar operation and functionality as the system 100 of FIG. 1. However, the system 200 provides additional details regarding the components of the wireless power transfer system 200 as compared to FIG. 1. The system 200 includes a transmitter 204 and a receiver 208. The transmitter 204 includes transmit circuitry 206 that includes an oscillator 222, a driver circuit 224, and a filter and matching circuit 226. The oscillator 222 may be configured to generate a signal at a desired frequency that may be adjusted in response to a frequency control signal 223. The oscillator 222 provides the oscillator signal to the driver circuit 224. The driver circuit 224 may be configured to drive the transmit coupler 214 at a resonant frequency of the transmit coupler 214 based on an input voltage signal (V_{D}) 225.

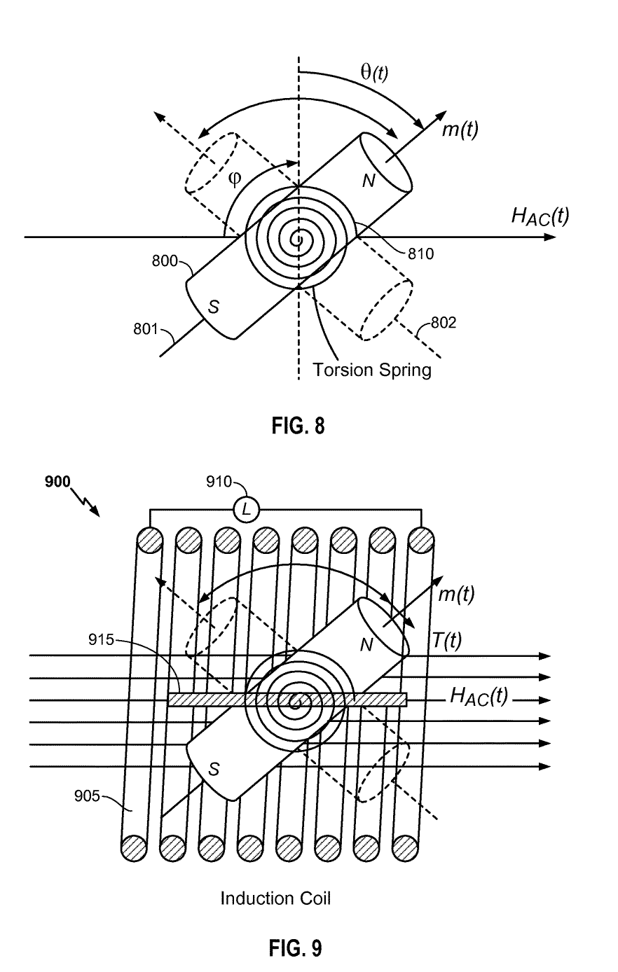

The filter and matching circuit 226 filters out harmonics or other unwanted frequencies and matches the impedance of the transmit circuitry 206 to the impedance of the transmit coupler 214. As a result of driving the transmit coupler 214, the transmit coupler 214 generates a wireless field 205 to wirelessly output power at a level sufficient for charging a battery 236. As will be described in more detail in connection with FIGS. 8-23 below, the transmit coupler 214 may be configured to excite one or more (e.g., a 2-dimensional or 3-dimensional array of) magneto-mechanical oscillators (not shown in FIG. 2) to physically oscillate about at least one rotation axis in resonance with the wireless field 205. The physical resonant oscillation of the oscillators may reinforce the wireless field 205, increasing its strength.

The receiver 208 comprises receive circuitry 210 that includes a matching circuit 232 and a rectifier circuit 234. The matching circuit 232 may match the impedance of the receive circuitry 210 to the impedance of the receive coupler 218. The rectifier circuit 234 may generate a direct current (DC) power output from an alternate current (AC) power input to charge the battery 236. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205. In some implementations, the receiver 208 may be configured to determine whether an amount of power transmitted by the transmitter 204 and received by the receiver 208 is appropriate for charging the battery 236.

FIG. 3 is a schematic diagram of a portion of the transmit circuitry 206 or the receive circuitry 210 of FIG. 2. As illustrated in FIG. 3, transmit or receive circuitry 350 may include a coupler 352. The coupler 352 may also be referred to or be configured as a “conductor loop”, a coil, an antenna, an inductor, or a “magnetic” coupler. The term “coupler” generally refers to a component that may wirelessly output or receive energy for coupling to another “coupler.”

The resonant frequency of the loop or magnetic couplers is based on the inductance and capacitance of the loop or magnetic coupler. Inductance may be simply the inductance created by the coupler 352, whereas, capacitance may be added via a capacitor (or the self-capacitance of the coupler 352) to create a resonant structure at a desired resonant frequency. As a non-limiting example, a capacitor 354 and a capacitor 356 may be added to the transmit or receive circuitry 350 to create a resonant circuit configured to resonate at a resonant frequency. For larger sized couplers using large diameter couplers exhibiting larger inductance, the value of capacitance needed to produce resonance may be lower. Furthermore, as the size of the coupler increases, coupling efficiency may increase. This is mainly true if the size of both transmit and receive couplers increase. For transmit couplers, the signal 358, with a frequency that substantially corresponds to the resonant frequency of the coupler 352, may be an input to the coupler 352. For receive couplers, the signal 358 may be output to charge or power a load.

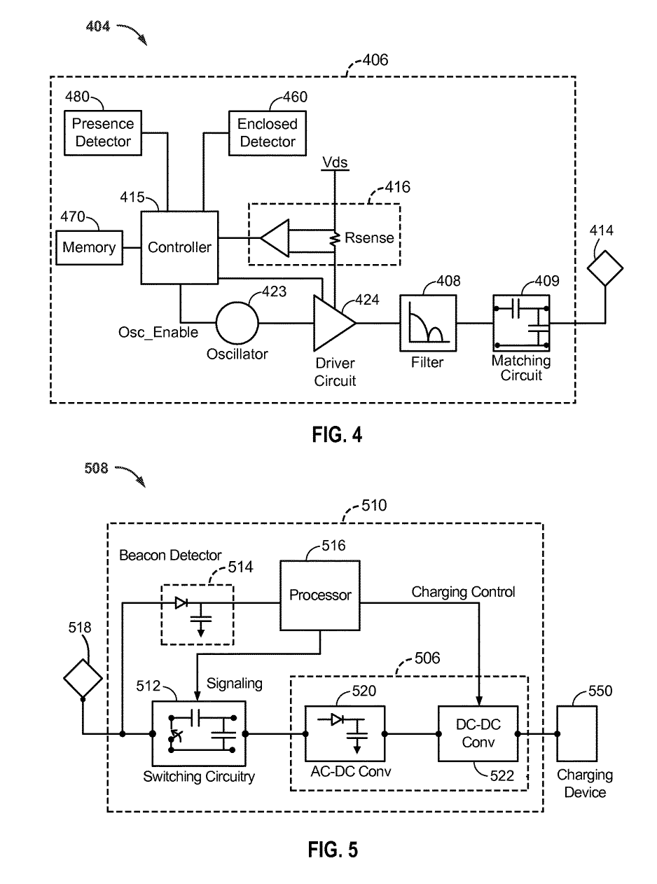

FIG. 4 is a functional block diagram of a transmitter 404 that may be used in the wireless power transfer system of FIG. 1, in accordance with some exemplary implementations of the invention. The transmitter 404 may include transmit circuitry 406 and a transmit coupler 414. The transmit coupler 414 may be the coupler 352 as shown in FIG. 3. Transmit circuitry 406 may provide power to the transmit coupler 414 by providing an oscillating signal resulting in generation of energy (e.g., magnetic flux) about the transmit coupler 414. Transmitter 404 may operate at any suitable frequency.

Transmit circuitry 406 may include a fixed impedance matching circuit 409 for matching the impedance of the transmit circuitry 406 (e.g., 50 ohms) to the impedance of the transmit coupler 414 and a low pass filter (LPF) 408 configured to reduce harmonic emissions to levels to prevent self-jamming of devices coupled to a receiver 108 (FIG. 1). Other exemplary implementations may include different filter topologies, including but not limited to, notch filters that attenuate specific frequencies while passing others and may include an adaptive impedance match, that may be varied based on measurable transmit metrics, such as output power to the coupler 414 or DC current drawn by the driver circuit 424. Transmit circuitry 406 further includes a driver circuit 424 configured to drive a signal as determined by an oscillator 423. The transmit circuitry 406 may be comprised of discrete devices or circuits, or alternately, may be comprised of an integrated assembly. An exemplary power output from the transmit coupler 414 may be on the order of anywhere from 0.5 Watts, to 1 Watt, to 2.5 Watts, to 50 Watts and the like. Higher or lower power levels are also contemplated. For example, if aspects described herein are implemented on a scale for charging a load such as an electric vehicle, power output may be on the order of kilowatts.

Transmit circuitry 406 may further include a controller 415 for selectively enabling the oscillator 423 during transmit phases (or duty cycles) for specific receivers, for adjusting the frequency or phase of the oscillator 423, and for adjusting the output power level for implementing a communication protocol for interacting with neighboring devices through their attached receivers. It is noted that the controller 415 may also be referred to herein as a processor. Adjustment of oscillator phase and related circuitry in the transmission path may allow for reduction of out of band emissions, especially when transitioning from one frequency to another.

The transmit circuitry 406 may further include a load sensing circuit 416 for detecting the presence or absence of active receivers in the vicinity of the near-field generated by transmit coupler 414. By way of example, a load sensing circuit 416 monitors the current flowing to the driver circuit 424, that may be affected by the presence or absence of active receivers in the vicinity of the field generated by transmit coupler 414 as will be further described below. Detection of changes to the loading on the driver circuit 424 are monitored by controller 415 for use in determining whether to enable the oscillator 423 for transmitting energy and to communicate with an active receiver. As described more fully below, a current measured at the driver circuit 424 may be used to determine whether an invalid device is positioned within a wireless power transfer region of the transmitter 404.

The transmit coupler 414 may include a component including Litz wire or as an coupler strip with the thickness, width and metal type selected to keep resistive losses low. In a one implementation, the transmit coupler 414 may generally be configured for association with a larger structure such as a table, mat, lamp or other less portable configuration. A transmit coupler may also use a system of magneto-mechanical oscillators in accordance with some exemplary implementations described herein.

The transmitter 404 may gather and track information about the whereabouts and status of receiver devices that may be associated with the transmitter 404. Thus, the transmit circuitry 406 may include a presence detector 480, an enclosed detector 460, or a combination thereof, connected to the controller 415 (also referred to as a processor herein). The controller 415 may adjust an amount of power delivered by the driver circuit 424 in response to presence signals from the presence detector 480 and the enclosed detector 460. The transmitter 404 may receive power through a number of power sources, such as, for example, an AC-DC converter (not shown) to convert AC power present in a building, a DC-DC converter (not shown) to convert a DC power source to a voltage suitable for the transmitter 404, or directly from a DC power source (not shown).

FIG. 5 is a functional block diagram of a receiver 508 that may be used in the wireless power transfer system of FIG. 1, in accordance with some exemplary implementations of the invention. The receiver 508 includes receive circuitry 510 that may include a receive coupler 518. Receiver 508 further couples to device 550 for providing received power thereto. It should be noted that receiver 508 is illustrated as being external to device 550 but may be integrated into device 550. Energy may be propagated wirelessly to receive coupler 518 and then coupled through the rest of the receive circuitry 510 to device 550. By way of example, the charging device may include devices such as mobile phones, vehicles, portable music players, laptop computers, tablet computers, computer peripheral devices, communication devices (e.g., Bluetooth devices), digital cameras, hearing aids (and other medical devices), and the like.

Receive coupler 518 may be tuned to resonate at the same frequency, or within a specified range of frequencies, as transmit coupler 414 (FIG. 4). Receive coupler 518 may be similarly dimensioned with transmit coupler 414 or may be differently sized based upon the dimensions of the associated device 550. By way of example, device 550 may be a portable electronic device having diametric or length dimension smaller than the diameter or length of transmit coupler 414.

Receive circuitry 510 may provide an impedance match to the receive coupler 518. Receive circuitry 510 includes power conversion circuitry 506 for converting received energy into charging power for use by the device 550. Power conversion circuitry 506 includes an AC-to-DC converter 520 and may also include a DC-to-DC converter 522. AC-to-DC converter 520 rectifies the AC energy signal received at receive coupler 518 into a non-alternating power with an output voltage represented by V_{rect}. The DC-to-DC converter 522 (or other power regulator) converts the rectified AC energy signal into an energy potential (e.g., voltage) that is compatible with device 550 with an output voltage and output current. Various AC-to-DC converters are contemplated, including partial and full rectifiers, regulators, bridges, doublers, as well as linear and switching converters.

Receive circuitry 510 may further include switching circuitry 512 for connecting receive coupler 518 to the power conversion circuitry 506 or alternatively for disconnecting the power conversion circuitry 506. Disconnecting receive coupler 518 from power conversion circuitry 506 not only suspends charging of device 550, but also changes the “load” as “seen” by the transmitter 404 (FIG. 2).

In some exemplary implementations, communication between the transmitter 404 and the receiver 508 refers to a device sensing and charging control mechanism. In other words, the transmitter 404 may use on/off keying of the transmitted signal to adjust whether energy is available in the near-field. The receiver may interpret these changes in energy as a message from the transmitter 404. From the receiver side, the receiver 508 may use tuning and de-tuning of the receive coupler 518 to adjust how much power is being accepted from the field. In some cases, the tuning and de-tuning may be accomplished via the switching circuitry 512. The transmitter 404 may detect this difference in power used from the field and interpret these changes as a message from the receiver 508. It is noted that other forms of modulation of the transmit power and the load behavior may be utilized.

Receive circuitry 510 may further include signaling detector and beacon circuitry 514 used to identify received energy fluctuations that may correspond to informational signaling from the transmitter to the receiver. Furthermore, signaling and beacon circuitry 514 may also be used to detect the transmission of a reduced signal energy (i.e., a beacon signal) and to rectify the reduced signal energy into a nominal power for awakening either un-powered or power-depleted circuits within receive circuitry 510 in order to configure receive circuitry 510 for wireless charging.

Receive circuitry 510 further includes processor 516 for coordinating the processes of receiver 508 described herein including the control of switching circuitry 512 described herein. Processor 516 may monitor beacon circuitry 514 to determine a beacon state and extract messages sent from the transmitter 404. Processor 516 may also adjust the DC-to-DC converter 522 for improved performance.

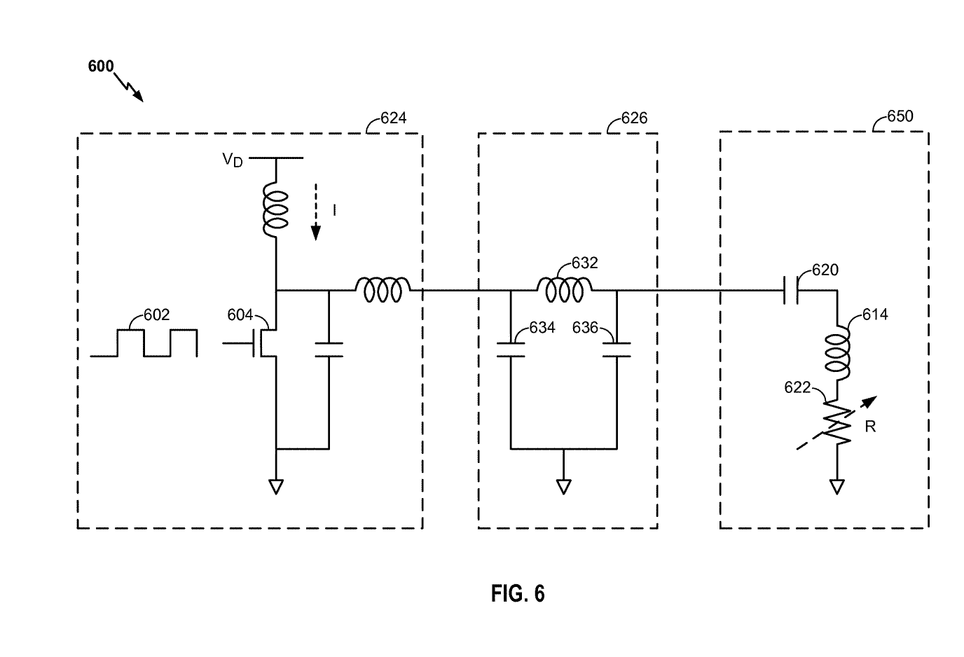

FIG. 6 is a schematic diagram of a portion of transmit circuitry 600 that may be used in the transmitter 404 of FIG. 4. The transmit circuitry 600 may include a driver circuit 624 as described above in FIG. 4. The driver circuit 624 may be a switching amplifier that may be configured to receive a square wave and output a sine wave to be provided to the transmit circuit 650. In some cases the driver circuit 624 may be referred to as an amplifier circuit. The driver circuit 624 may be driven by an input signal 602 from an oscillator 423 as shown in FIG. 4. The driver circuit 624 may also be provided with a drive voltage V_{D} that is configured to control the maximum power that may be delivered through a transmit circuit 650. To eliminate or reduce harmonics, the transmit circuitry 600 may include a filter circuit 626. The filter circuit 626 may be a three pole (capacitor 634, inductor 632, and capacitor 636) low pass filter circuit 626.

The signal output by the filter circuit 626 may be provided to a transmit circuit 650 comprising a coupler 614 and capacitor 620 coupled in series with coupler 614. The transmit circuit 650 may include a series resonant circuit that may resonate at a frequency of the filtered signal provided by the driver circuit 624. The load of the transmit circuit 650 may be represented by the variable resistor 622. The load may be a function of a receiver 508 that is positioned to receive power from the transmit circuit 650.

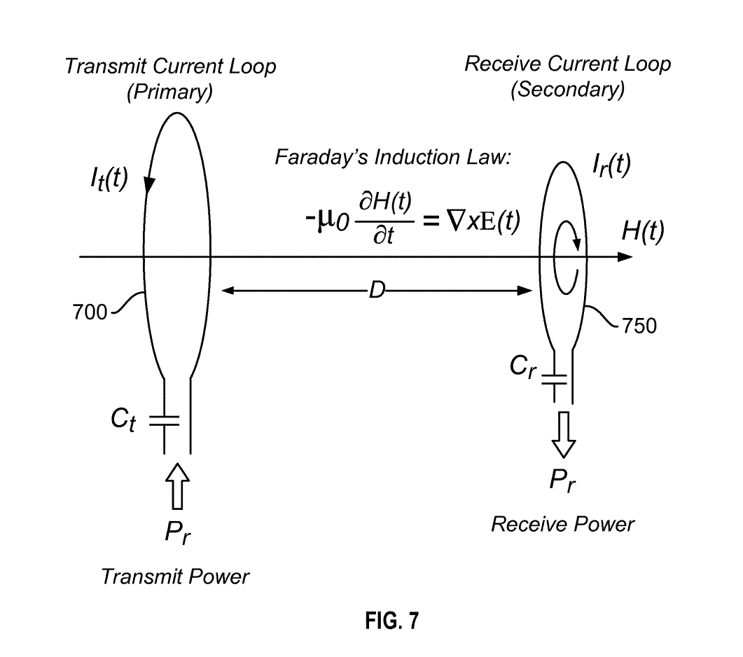

FIG. 7 illustrates non-radiative energy transfer that is based on Faraday's induction law, which may be expressed as:

$$- {μ}_{0} \frac{\partial H ( t )}{\partial t} = ∇ \times E ( t ) where ∇ \times E ( t )$$

denotes curl of the electric field generated by the alternating magnetic field. A transmitter forms a primary coupler (e.g., a transmit coupler as described above) and a receiver forms a secondary coupler (e.g., a receiver coupler as described above) separated by a transmission distance. The primary coupler represents the transmit coupler generating an alternating magnetic field. The secondary coupler represents the receive coupler that extracts electrical power from the alternating magnetic field using Faraday's induction law.

The generally weak coupling that exists between the primary coupler and secondary coupler may be considered as a stray inductance. This stray inductance, in turn, increases the reactance, which itself may hamper the energy transfer between primary coupler and secondary coupler. The transfer efficiency of this kind of weakly coupled system may be improved by using capacitors that are tuned to the precise opposite of the reactance at the operating frequency. When a system is tuned in this way, it becomes a compensated transformer which is resonant at its operating frequency. The power transfer efficiency is then only limited by losses in the primary coupler and secondary coupler. These losses are themselves defined by their quality or Q factors and the coupling factor between the primary coupler and the secondary coupler. Different tuning approaches may be used. Examples include, but are not limited to, compensation of the full reactance as seen at the primary coupler or secondary coupler (e.g., when either is open-circuited), and compensation of stray inductance. Compensation may also be considered as part of the source and load impedance matching in order to maximize the power transfer. Impedance matching in this way can hence increase the amount of power transfer.

As the distance D between the transmitter 700 and the receiver 750 increases, the efficiency of the transmission can decrease. At increased distances, larger loops, and/or larger Q factors may be used to improve the efficiency. However, when these devices are incorporated into a portable device, the size of the loop, thus its coupling and its Q-factor, may be limited by the parameters of the portable device.

Efficiency may be improved by reducing coupler losses. In general, losses may be attributed to imperfectly conducting materials, and eddy currents in the proximity of the loop. At lower frequencies (e.g., such as less than 1 MHz), flux magnification materials such as ferrite materials may be used to artificially increase the size of the coupler. Eddy current losses may inherently be reduced by concentrating the magnetic field. Special kinds of wire can also be used to lower the resistance, such as stranded or Litz wire at low frequencies to mitigate skin effect.

A species of resonant inductive energy transfer uses a magneto-mechanical system as described herein. The magneto-mechanical system may be part of an energy receiving system that picks up energy from an alternating magnetic field, converts it to mechanical energy, and then reconverts that mechanical energy into electrical energy using Faraday's induction law.

According to an implementation, the magneto-mechanical system is formed of a magnetic element, e.g. a permanent magnetic element, which is mounted in a way that allows it to oscillate under the force of an external alternating magnetic field. This transforms energy from the magnetic field into mechanical energy. In an implementation, this oscillation uses rotational moment around an axis perpendicular to the vector of the magnetic dipole moment m, and is also positioned in the center of gravity of the magnetic element. This allows equilibrium and thus minimizes the effect of the gravitational force. A magnetic field applied to this system produces a torque of T=μ₀(m×H). This torque tends to align the magnetic dipole moment of the elementary magnetic element along the direction of the field vector. Assuming an alternating magnetic field, the torque accelerates the moving magnet(s), thereby transforming the oscillating magnetic energy into mechanical energy.

For example, in some implementations, a transmit coupler, e.g., as shown in any of FIGS. 1-4 and 7, may be utilized to generate a time-varying exciting magnetic field that may cause one or more first magneto-mechanical oscillators, as will be described below, to physically oscillate. Such physical oscillation of magnetic elements within the first oscillators may cause the first oscillators themselves to further generate a time-varying excited magnetic field at substantially the same frequency as the exciting magnetic field. In some implementations, this excited magnetic field may cause one or more second magneto-mechanical oscillators at a distance from the first oscillators to physically oscillate at the frequency of the excited magnetic field generated by the first oscillators, which in turn, causes magnetic elements within the second oscillators to generate an excited magnetic field at that frequency. A receive coupler, e.g., as shown in any of FIGS. 1-3, 5 and 7, located near or around the second oscillators may generate an alternating current under the influence of the excited magnetic field generated by the second oscillators.

FIG. 8 schematically illustrates an example magneto-mechanical oscillator, in accordance with some exemplary implementations. The magneto-mechanical oscillator of FIG. 8 comprises a magnetic element 800 having a magnetic moment m(t) (e.g., a vector having a constant magnitude but an angle that is time-varying, such as a magnetic dipole moment) and the magnetic element 800 is mechanically coupled to an underlying substrate (not shown) by at least one spring (e.g., a torsion spring 810). This spring holds the magnetic element in position shown as 801 when no torque from the magnetic field is applied. Magnetic torque causes the magnetic element 800 to move against the restoring force of the torsion spring 810, to the position 802, against the force of the spring with spring constant K_{R}. The magneto-mechanical oscillator may be considered a torsion pendulum with an inertial moment I and exhibiting a resonance at a frequency proportional to K_{R} and I. Frictional losses and in most cases a very weak electromagnetic radiation is caused by the oscillating magnetic moment. If this magneto-mechanical oscillator is subjected to an alternating field H_{AC}(t) with a frequency near the resonance frequency of the magneto-mechanical oscillator, then the magneto-mechanical oscillator will oscillate with an angular displacement θ(t) depending on the intensity of the applied magnetic field and reaching a maximum, peak displacement at resonance.

According to another implementation, some or all of the restoring force of the spring may be replaced by an additional static magnetic field H₀. This static magnetic field may be oriented to provide the torque T₀=μ₀ (m×H₀). Another implementation may use both the spring and a static magnetic field to produce the restoring force of the magneto-mechanical oscillator. The mechanical energy is reconverted into electrical energy using Faraday induction, e.g. the dynamo principle. This may be used for example an induction coil 905 wound around the magneto-electrical system 900 as shown in FIG. 9. In another example, the mechanical energy is reconverted into electrical energy using another type of circuit configured to directly convert the mechanical motion into electrical power or otherwise couple energy from the magnetic field generated by the moving magnets. A load such as 910 may be connected across the coil 905. This load appears as a mechanical torque dampening the system and lowering the Q factor of the magneto-mechanical oscillator. In addition, when magnetic elements are oscillating and thus generating a strong alternating magnetic field component and if the magnetic elements are electrically conducting, eddy currents in the magnetic elements will occur. These eddy currents will also contribute to system losses.

In general, some eddy currents may be also produced by the alternating magnetic field that results from the current in the coupling coil. Smaller magnetic elements in the magneto-mechanical system may reduce eddy current effects. According to an implementation, an array of smaller magnetic elements is used in order to minimize this loss effect.

A magneto-mechanical system will exhibit saturation if the angular displacement of the magnetic element reaches a peak value. This peak value may be determined from the direction and intensity of the external H field or by the presence of a displacement stopper such as 915 to protect the torsion spring against plastic deformation. This may also be limited by the packaging, such as the limited available space for a magnetic element to rotate within. Electric breaking by modifying the electric loading may be considered an alternative method to control saturation and thus prevent damaging the magneto-mechanical system.

According to one implementation and assuming a loosely coupled regime (e.g., weak coupling, such as in the case of energy harvesting from an external magnetic field generated by a large loop antenna surrounding a large space), optimum matching may be obtained when the loaded Q becomes half of the unloaded Q. According to an implementation, the induction coil is designed to fulfill that condition to maximize the amount of output power. If coupling between transmitter and receiver is stronger (e.g., a tightly coupled regime), optimum matching may utilize a loaded Q that is significantly smaller than the unloaded Q.

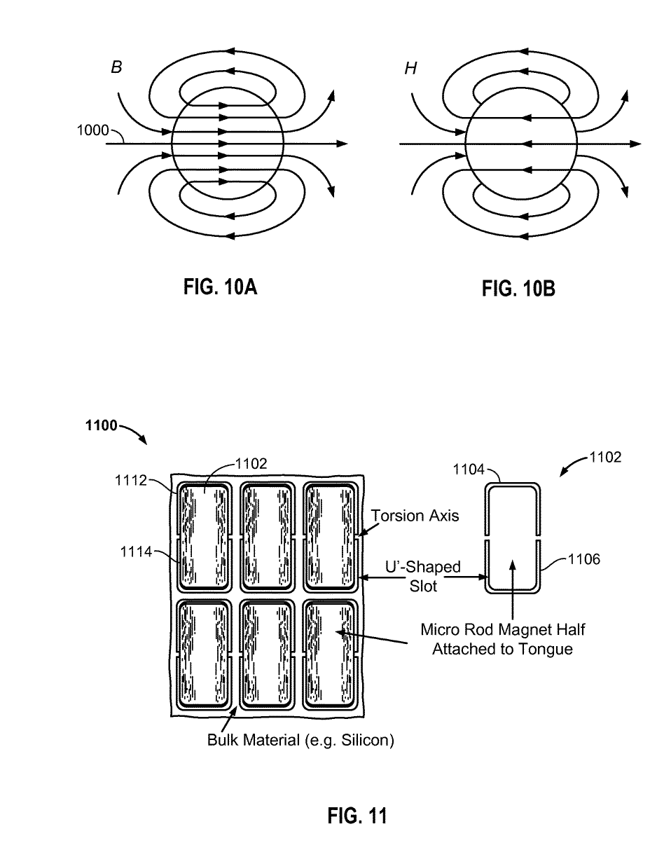

When using an array of such moving magnets, there may be mutual coupling between the magnetic elements forming the array. This mutual coupling can cause internal forces and demagnetization. According to an implementation, the array of magnetic elements may be radially symmetrical, e.g., spheroids, either regular or prolate, as shown in FIGS. 10A and 10B. FIG. 10A shows the parallel field lines of the magnetic flux density in a magnetized sphere. FIG. 10B shows the corresponding magnetic field strength (H) in a magnetized sphere. From these figures that may be seen that there may be virtually zero displacement forces between magnetic elements in a spheroid shaped three-dimensional array.

Therefore, the magnetic elements are preferably in-line with an axis 1000 of the spheroid or the disc. This causes the internal forces to vanish for angular displacement of the magnets. This causes the resonance frequency to be solely defined by the mechanical system parameters. A sphere has these advantageous factors, but may also have a demagnetization factor is low as ⅓, where an optimum demagnetization factor is one. Assuming equal orientation of axes in all directions, a disc shaped array can also be used. A disc-shaped 3D array may also result in low displacement forces, if the disc radius is much larger than its thickness and if the magnetic elements are appropriately oriented and suspended. Discs may have a higher magnetization factor, for example closer to 1.

Magnetization factor of a disc will depend on the width to diameter ratio. A disc-shaped array may be packaged into a form factor that is more suitable for integration into a device, since spheroids do not have a flat part that may be easily used without increasing the thickness of the host device.

In addition, theoretical analysis of wireless energy transfer based on magneto-mechanical systems shows that within a first order approximation and in a weakly coupled regime, the energy transfer efficiency increases proportionally to the Q-factor and to the square of the magnetization, and is inversely proportional to the density of the inertial moment. In addition, the maximum transferable power, which is limited by saturation effects, increases proportionally to the frequency, to the square of the product of the magnetic moments, and to the peak angular displacement of the magnets.

Certain implementation use micro-electromechanical systems (MEMS) to create the magneto-mechanical systems. It may be desirable to utilize magneto-mechanical metamaterials. The metamaterial may have a high total magnetic moment per volume (i.e., a high remanence of the permanent magnetic material, a high packing density described by the volume fraction of magnetic material or fill factor). Remanence may also be called “remanent magnetization” and is the magnetization left behind in a ferromagnetic material after an external magnetic field is removed. Elementary oscillators should have a small size in order to minimize a moment of inertia per volume. The metamaterial should have low losses (i.e., the elementary oscillators should have a high unloaded Q, e.g., 500+, depending upon the operating conditions of the system. The displacement angles of the elementary oscillator magnetic elements should be relatively large, e.g., preferably more than ±10° in either direction. The metamaterial should be designed to achieve a resonance frequency in the Hz to MHz range. The metamaterial should have sufficient mechanical stability to be durable and processable and should exhibit relatively low fatigue of mechanical elements to increase mean life time. The metamaterial should be manufacturable utilizing a cost effective process. However, some of these preferences may be contradictory. For example, a desired spring constant of the oscillators may be limited by the size of the oscillator and materials of its construction (e.g., soft springs cannot be made arbitrarily small and still retain functionality and suitable lifetimes). Also, greater displacement angles of the oscillators may adversely affect possible fill factors due to the greater range of motion and need for space to accommodate the same.

FIG. 11 schematically illustrates an example array of magneto-mechanical oscillators, in accordance with some exemplary implementations. An array 1100 may be formed of a number of magnetic elements such as 1102. Each magnetic element 1102 is formed of two U-shaped slots 1112, 1114 that are micro-machined or etched into a silicon substrate. A permanent rod magnetic element 1104, 1106 of similar size is formed within the slots. As a non-limiting example, the magnetic element may be 10 μm or smaller. However in other cases the size may be in the range of millimeters. At the micrometer level, crystalline materials may behave differently than larger sizes. Hence, this system can provide considerable angular displacement e.g. as high as 10° or more and extremely high Q factors. Other configurations, in accordance with some exemplary implementations can instead utilize other structures (e.g., torsional springs), in other positions and/or in other orientations, which couple the magneto-mechanical oscillators to the surrounding material.

These devices may be formed in a single bulk material such as silicon. FIG. 11 shows an example structure, in accordance with some exemplary implementations. In an example configuration, the magnetic elements 1102 shown in FIG. 11 may be fabricated in a two-dimensional structure in a common plane (e.g., a portion of a planar silicon wafer, shown in FIG. 11 in a top view, oriented parallel to the plane of the page) and such two-dimensional structures may be assembled together to form a three-dimensional structure. However, the example structure shown in FIG. 11 should not be interpreted as only being in a two-dimensional wafer structure. In other example configurations, different sub-sets of the magnetic elements 1102 may be fabricated in separate structures that are assembled together to form a three-dimensional structure (e.g., the three top magnetic elements 1102, shown in FIG. 11 in a side view, may be fabricated in a portion of one silicon wafer oriented perpendicularly to the plane of the page and the three bottom magnetic elements 1102, shown in FIG. 11 in a side view, may be fabricated in a portion of another silicon wafer oriented perpendicularly to the plane of the page).

The magnetic elements 1104, 1106 can have a high magnetization, e.g., higher than 1 Tesla. In some exemplary implementations, the magnetic element itself may be composed of two half pieces, one piece attached to the upper side and the other piece attached to the lower side. These devices may be mounted so that the center of gravity coincides with the rotational axes. The device may be covered with a low friction material, or may have a vacuum located in the area between the tongue and bulk material in order to reduce type the friction.

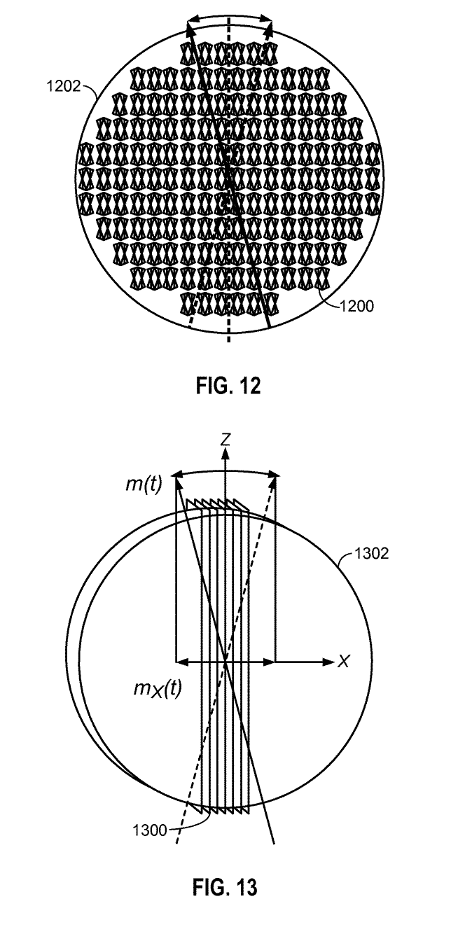

FIG. 12 schematically illustrates a cut through area of a three-dimensional array of magneto-mechanical oscillators 1200, in accordance with some exemplary implementations. While the example structure shown in FIG. 12 could be in a single two-dimensional wafer structure oriented parallel to the page, FIG. 12 should not be interpreted as only being in a two-dimensional wafer structure. For example, the three-dimensional array 1202 through which FIG. 12 shows a two-dimensional cut can comprise a plurality of planar wafer portions oriented perpendicularly to the page such that the cross-sectional view of FIG. 12 includes side views of magneto-mechanical oscillators 1200 from multiple such planar wafer portions. In one implementation, the array 1202 itself is formed of a radial symmetric shape, such as disc shaped. The disc shaped array 1202 of FIG. 12 may provide a virtually constant demagnetization factor at virtually all displacement angles. In this implementation, an induction coil may be wound around the disc to pick up the dynamic component of the oscillating induction field generated by the magneto-mechanical system. The resulting dynamic component of the system may be expressed as

mₓ(t)=|m|·sin θ(t)·eₓ

FIG. 13 schematically illustrates an example induction coil 1300 wound around a disk 1302 having a plurality of magneto-mechanical oscillators, in accordance with some exemplary implementations.

The implementations described and particularly below may be incorporated into either transmitters or receiver devices. While the description below discloses various features of a power transmitter or a power receiver, many of these same concepts and structures of the power transmitter or receiver may be used in a power receiver or transmitter as well, in accordance with some exemplary implementations. Furthermore, a power transfer system comprising at least one power transmitter and at least one power receiver can have one or both of the at least one power transmitter and the at least one power receiver having a structure as described herein.

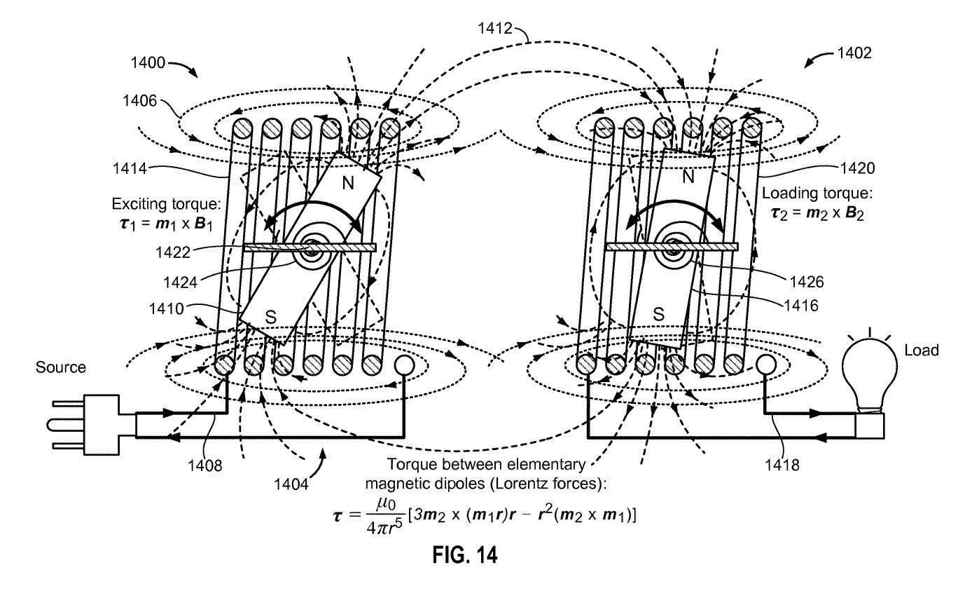

FIG. 14 schematically illustrates an example power transmitter 1400 configured to wirelessly transfer power to at least one power receiver 1402, in accordance with some exemplary implementations. The power transmitter 1400 comprises at least one excitation circuit 1404 configured to generate a time-varying (e.g., alternating) magnetic field 1406 in response to a time-varying (e.g., alternating) electric current 1408 flowing through the at least one excitation circuit 1404. The time-varying magnetic field 1406 has an excitation frequency. The power transmitter 1400 further comprises a plurality of magneto-mechanical oscillators 1410 (e.g., that are mechanically coupled to at least one substrate, which is not shown in FIG. 14). FIG. 14 schematically illustrates one example magneto-mechanical oscillator 1410 compatible with certain implementations described herein for simplicity, rather than showing the plurality of magneto-mechanical oscillators 1410. Each magneto-mechanical oscillator 1410 of the plurality of magneto-mechanical oscillators has a mechanical resonant frequency substantially equal to the excitation frequency. The plurality of magneto-mechanical oscillators 1410 is configured to generate a time-varying (e.g., alternating) magnetic field 1412 in response to movement of the plurality of magneto-mechanical oscillators 1410 under the influence of the first magnetic field 1406.

As schematically illustrated by FIG. 14, the at least one excitation circuit 1404 comprises at least one coil 1414 surrounding (e.g., encircling) at least a portion of the plurality of magneto-mechanical oscillators 1410. The at least one coil 1414 has a time-varying (e.g., alternating) current 1408 I₁(t) flowing through the at least one coil 1414, and generates a time-varying (e.g., alternating) first magnetic field 1406 which applies a torque (labeled as “exciting torque” in FIG. 14) to the magneto-mechanical oscillators 1410. Although the coil 1414 is shown, the present application is not so limited and other types of excitation circuits capable of generating a time varying magnetic field for inducing motion of the oscillators. In response to the first time-varying magnetic field 1406, the magneto-mechanical oscillators 1410 rotate about an axis. In this way, the at least one excitation circuit 1404 and the plurality of magneto-mechanical oscillators 1410 convert electrical energy into mechanical energy. The magneto-mechanical oscillators 1410 generate a second magnetic field 1412 which wirelessly transmits power to the power receiver 1402 (e.g., a power receiver as described above). For example, the power receiver 1402 can comprise a receiving plurality of magneto-mechanical oscillators 1416 configured to rotate in response to a torque applied by the second magnetic field 1412 and to induce a current 1418 in a pick-up coil 1420 (e.g., a power extraction circuit), thereby converting mechanical energy into electrical energy. Although the pick-up coil 1420 is shown, the present application is not so limited and any power extraction circuit configured to convert the mechanical energy into electrical energy for powering a load is also contemplated. For example, piezoelectric material can be used to convert mechanical energy into electrical energy, either in place of pick-up coil 1420, or in conjunction with pick-up coil 1420.

As schematically illustrated by FIG. 14 for a pick-up coil for a power transmitter utilizing a plurality of magneto-mechanical oscillators, the at least one coil 1414 of the power transmitter 1400 can comprise a single common coil that is wound around at least a portion of the plurality of magneto-mechanical oscillators 1410 of the power transmitter 1400. The wires of the at least one coil 1414 may be oriented substantially perpendicular to the “dynamic” component (described in more detail below) of the magnetic moment of the plurality of magneto-mechanical oscillators 1410 to advantageously improve (e.g., maximize) coupling between the at least one coil 1414 and the plurality of magneto-mechanical oscillators 1410. As described more fully below, the excitation current flowing through the at least one coil 1414 may be significantly lower than those used in other resonant induction systems. Thus, certain implementations described herein advantageously do not have special requirements for the design of the at least one coil 1414.

As described above with regard to FIG. 11 for the magneto-mechanical oscillators of a power receiver, the magneto-mechanical oscillators 1410 of the power transmitter 1400, in accordance with some exemplary implementations may be structures fabricated on at least one substrate (e.g., a semiconductor substrate, a silicon wafer) using lithographic processes such as are known from such fabrication techniques. Each magneto-mechanical oscillator 1410 of the plurality of magneto-mechanical oscillators 1410 can comprise a movable magnetic element configured to rotate about an axis 1422 in response to a torque applied to the movable magnetic element by the first magnetic field 1406. The movable magnetic element may comprise at least one spring 1424 (e.g., torsion spring, compression spring, extension spring) mechanically coupled to the substrate and configured to apply a restoring force to the movable magnetic element in response to rotation of the movable magnetic element. The magneto-mechanical oscillators 1416 of the power receiver 1402 can comprise a movable magnetic element (e.g., magnetic dipole) comprising at least one spring 1426 (e.g., torsion spring, compression spring, extension spring) mechanically coupled to a substrate of the power receiver 1402 and configured to apply a restoring force to the movable magnetic element in response to rotation of the movable magnetic element.

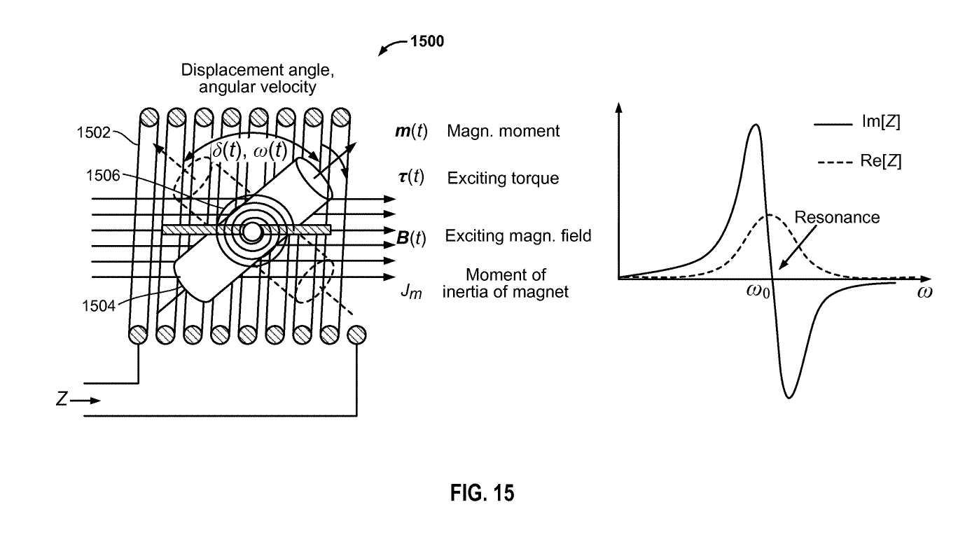

FIG. 15 schematically illustrates an example power transmitter 1500, in accordance with some exemplary implementations in which the at least one excitation circuit 1502 is driven at a frequency substantially equal to a mechanical resonant frequency of the magneto-mechanical oscillators 1504. The at least one excitation circuit 1502 generates the first magnetic field which applies the exciting torque to the magneto-mechanical oscillator 1504, which has a magnetic moment and a moment of inertia. The direction of the magnetic moment is time-varying, but its magnitude is constant. The resonant frequency of a magneto-mechanical oscillator 1504 is determined by the mechanical properties of the magneto-mechanical oscillator 1504, including its moment of inertia (a function of its size and dimensions) and spring constants.

The input impedance of the at least one excitation circuit 1502 has a real component and an imaginary component, both of which vary as a function of frequency. Near the resonant frequency of the magneto-mechanical oscillators 1504, the real component is at a maximum, and the imaginary component disappears (e.g., is substantially equal to zero) (e.g., the current and voltage of the at least one excitation circuit 1502 are in phase with one another). At this frequency, the impedance, as seen at the terminals of the at least one coil, appears as purely resistive, even though a strong alternating magnetic field may be generated by the magneto-mechanical oscillators. The combination of the at least one excitation circuit 1502 and the plurality of magneto-mechanical oscillators 1504 can appear as an “inductance-less inductor” which advantageously avoids (e.g., eliminates) the need for resonance-tuning capacitors as are used in other power transmitters.

Since the time-varying (e.g., alternating) second magnetic field is generated by the plurality of magneto-mechanical oscillators 1504, there are no high currents flowing through the electrical conductors of the at least one excitation circuit 1502 at resonance, such as exist in other resonant induction systems. Therefore, losses in the at least one excitation circuit 1502 (e.g., the exciter coil) may be negligible. In certain such configurations, thin wire or standard wire may be used in the at least one excitation circuit 1502, rather than Litz wire. The main losses occur in the plurality of magneto-mechanical oscillators 1504 and its surroundings due to mechanical friction, air resistance, eddy currents, and radiation in general. The magneto-mechanical oscillators 1504 can have Q-factors which largely exceed those of electrical resonators, particularly in the kHz and MHz ranges of frequencies. For example, the Q-factor of the plurality of magneto-mechanical oscillators 1504 (either in use for a transmitter system or a receiver system) may be greater than 500, or even greater than 10,000. Such high Q-factors may be more difficult to achieve in other resonant induction systems using capacitively loaded wire loops in some cases.

The large Q-factor of certain implementations described herein can also be provided by the plurality of magneto-mechanical oscillators 1504. The power that may be wirelessly transmitted to a load is the product of the root-mean-square (RMS) values of the torque τ_{RMS} applied to the magneto-mechanical oscillator 1504 and the frequency (e.g., angular velocity) ω_{RMS}. To allow for sufficient oscillation (e.g., sufficient angular displacement of the magneto-mechanical oscillator 1504) when power transfer distances increase, the torque τ_{RMS} (e.g., the dampening torque applied to the magneto-mechanical oscillator 1504 of a power transmitter 1500, or the loading torque applied to the magneto-mechanical oscillator of a power receiver) may be reduced, but such increased distances result in lower power. This power loss may be compensated for by increasing the frequency ω_{RMS}, within the limits given by the moment of inertia of the magneto-mechanical oscillators 1504 and the torsion springs 1506. The performance of the magneto-mechanical oscillator 1504 may be expressed as a function of the gyromagnetic ratio

$$γ = \frac{m}{{J}_{m}}$$

(where m is the magnetic moment of the magneto-mechanical oscillator 1504, and Jₘ is the moment of inertia of the magneto-mechanical oscillator 1504), and this ratio can advantageously be configured to be sufficiently high to produce sufficient performance at higher frequencies.

A plurality of small, individually oscillating magneto-mechanical oscillators arranged in a regular three-dimensional array can advantageously be used in a transmitter or receiver, instead of a single permanent magnetic element. The plurality of magneto-mechanical oscillators can have a larger gyromagnetic ratio than a single permanent magnetic element having the same total volume and mass as the plurality of magneto-mechanical oscillators. The gyromagnetic ratio of a three-dimensional array of N magneto-mechanical oscillators with a sum magnetic moment m and a sum mass Mₘ may be expressed as:

$$γ ( N ) = \frac{12 \cdot N \cdot \frac{m}{N}}{\frac{{NM}_{m}}{N} {( \frac{{l}_{m}}{\sqrt[3]{N}} )}^{2}} = \frac{12 m}{{M}_{m} {l}_{m}^{2}} {\sqrt[3]{N}}^{2}$$

where lₘ denotes the length of an equivalent single magnetic element (N=1).

This equation shows that the gyromagnetic ratio increases to the power of ⅔ with decreasing size of the magneto-mechanical oscillators. In other words, a large magnetic moment produced by an array of small magneto-mechanical oscillators may be accelerated and set into oscillation by a faint torque (e.g., the exciting torque produced by a small excitation current flowing through the at least one excitation current of a power transmitter or the loading torque in a power receiver produced by a distant power transmitter). The performance of the plurality of magneto-mechanical oscillators may be increased by increasing the number of magneto-mechanical oscillators since the magnetic moment increases more than does the moment of inertia by increasing the number of magneto-mechanical oscillators.

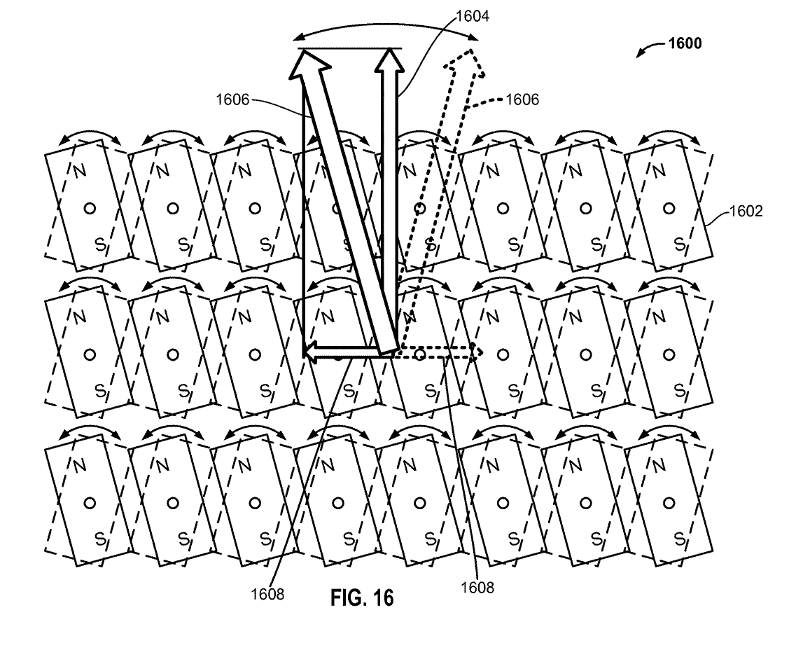

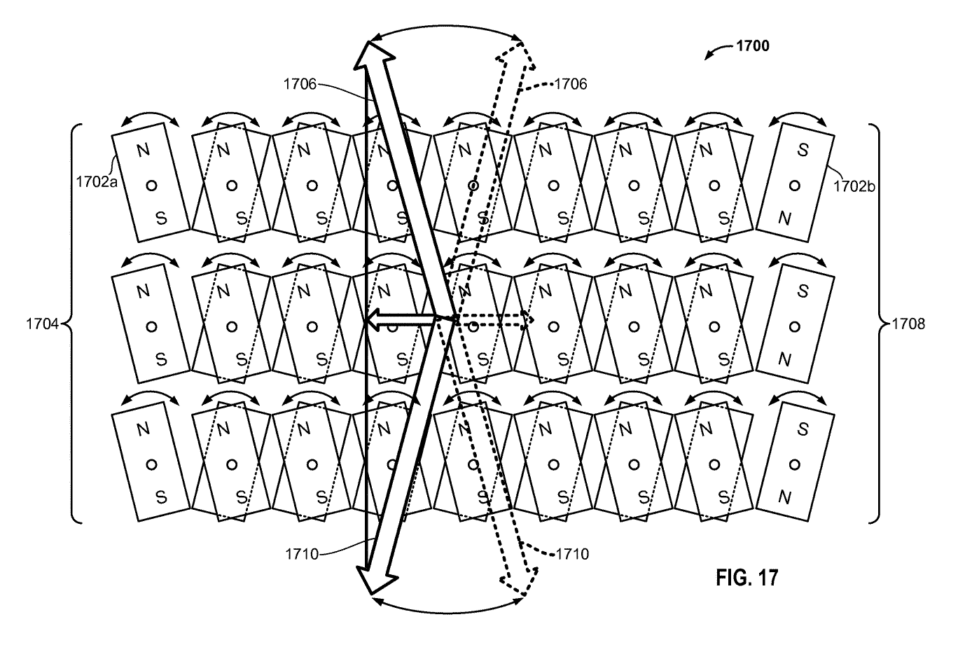

FIG. 16 schematically illustrates an example portion 1600 of a configuration of a plurality of magneto-mechanical oscillators 1602, in accordance with some exemplary implementations. The portion 1600 shown in FIG. 16 comprises a set of magneto-mechanical oscillators 1602. This arrangement of magneto-mechanical oscillators 1602 in a regular structure is similar to that of a plane in an atomic lattice structure (e.g., a three-dimensional crystal).

The oscillation of the magneto-mechanical oscillators 1602 between the solid positions and the dashed positions produces a sum magnetic moment that may be decomposed into a “quasi-static” component 1604 (denoted in FIG. 16 by the vertical solid arrow) and a “dynamic” component 1606 (denoted in FIG. 16 by the solid and dashed arrows at an angle to the vertical, and having a horizontal component 1608 shown by solid and dashed arrows). The dynamic component 1606 is responsible for energy transfer. For an example configuration such as shown in FIG. 16, for a maximum angular displacement of 30 degrees, a volume utilization factor of 20% for the set of magneto-mechanical oscillators 1602, a rare-earth metal magnetic material having 1.6 Tesla at its surface, a “dynamic” flux density in the order of 160 milli-Tesla peak may be achieved virtually without hysteresis losses, thereby outperforming certain other ferrite technologies.

However, the quasi-static component 1604 may be of no value in the energy transfer. In fact, in practical applications, it may be desirable to avoid (e.g., lessen or eliminate) the quasi-static component 1604, since it results in a strong magnetization (e.g., such as that of a strong permanent magnet) that can attract any magnetic materials in the vicinity of the structure towards the plurality of magneto-mechanical oscillators 1602.

The sum magnetic field generated by the plurality of magneto-mechanical oscillators 1602 can cause the individual magneto-mechanical oscillators 1602 to experience a torque such that they rest at a non-zero displacement angle. These forces may also change the effective torsion spring constant, thus modifying the resonant frequency. These forces may be controlled (e.g., avoided, reduced, or eliminated) by selecting the macroscopic shape of the array of the plurality of magneto-mechanical oscillators 1602 to be rotationally symmetric (e.g., a disk-shaped array). For example, using an array that is radially symmetrical (e.g., spheroidal, either regular or prolate, as shown in FIGS. 10A, 10B, and 12) can produce effectively zero displacement between the magneto-mechanical oscillators 1602 in a spheroid-shaped three-dimensional array. The field lines of some magnetic field components inside a magnetized disk are parallel for any orientation of the magnetic moment, and in a disk-shaped array, resonant frequencies may be determined mainly by the moment of inertia and the torsional spring constant of the magneto-mechanical oscillators.

FIG. 17 schematically illustrates an example configuration in which the plurality of magneto-mechanical oscillators 1702a and 1702b is arranged in a three-dimensional array 1700 in which the quasi-static components of various portions of the plurality of magneto-mechanical oscillators 1702 cancel one another, in accordance with some exemplary implementations. The three-dimensional array 1700 of FIG. 17 comprises at least one first plane 1704 (e.g., a first layer) comprising a first set of magneto-mechanical oscillators 1702a of the plurality of magneto-mechanical oscillators 1702, with each magneto-mechanical oscillator 1702a of the first set of magneto-mechanical oscillators 1702a having a magnetic moment pointing in a first direction. The first set of magneto-mechanical oscillators 1702a has a first summed magnetic moment 1706 (denoted in FIG. 17 by the top solid and dashed arrows) comprising a time-varying component and a time-invariant component. The three-dimensional array 1700 further comprises at least one second plane 1708 (e.g., a second layer) comprising a second set of magneto-mechanical oscillators 1702b of the plurality of magneto-mechanical oscillators 1702. Each magneto-mechanical oscillator 1702b of the second set of magneto-mechanical oscillators 1702b has a magnetic moment pointing in a second direction. The second set of magneto-mechanical oscillators 1702b has a second summed magnetic moment 1710 (denoted in FIG. 17 by the bottom solid and dashed arrows) comprising a time-varying component and a time-invariant component. The time-invariant component of the first summed magnetic moment 1706 and the time-invariant component of the second summed magnetic moment 1710 have substantially equal magnitudes as one another and point in substantially opposite directions as one another. In this way, the quasi-static components of the magnetic moments of the first set of magneto-mechanical oscillators 1702a and the second set of magneto-mechanical oscillators 1702b cancel one another out (e.g., by having the polarities of the magneto-mechanical oscillators alternate between adjacent planes of a three-dimensional array 1700). In contrast, the time-varying components of the first summed magnetic moment 1706 and the second summed magnetic moment 1710 have substantially equal magnitudes as one another and point in substantially the same direction as one another.

The structure of FIG. 17 is analogous to the structure of paramagnetic materials that have magnetic properties (e.g., a relative permeability greater than one) but that cannot be magnetized (e.g., soft ferrites). Such an array configuration may be advantageous, but can produce a counter-torque acting against the torque produced by an external magnetic field on the magneto-mechanical oscillators. This counter-torque will be generally added to the torque of the torsion spring. This counter-torque may be used as a restoring force to supplement that of the torsion spring or to be used in the absence of a torsion spring in the magneto-mechanical oscillator. In addition, the counter-torque may reduce the degrees of freedom in configuring the plurality of magneto-mechanical oscillators.

The fabrication of the magneto-mechanical oscillators, or other types of magnetic devices, can include a deposition of magnetic material that is “programmed” to have a particular direction, or orientation, for the magnetic moment. However, before being programmed, the orientation of the magnetic moment of the magnetic material of the devices within the array may be relatively random, or non-uniform.

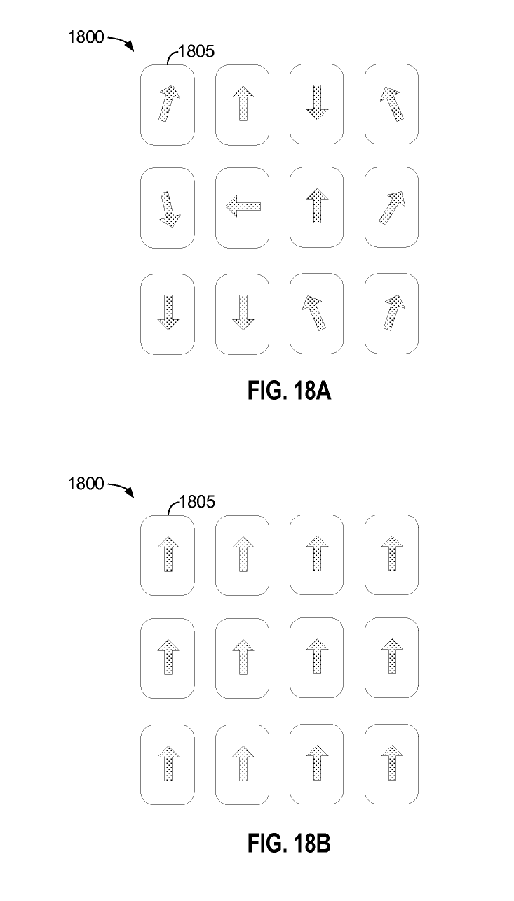

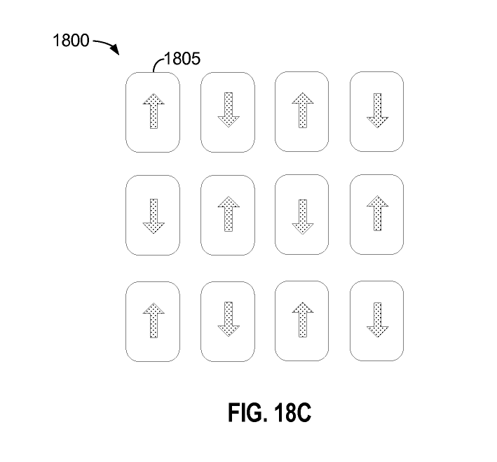

FIG. 18A illustrates non-uniform magnetic orientations of magnetic devices following a deposition of magnetic material, in accordance with some exemplary implementations. In FIG. 18A, the arrows in devices 1805 (e.g., a part of a magneto-mechanical oscillator) of array 1800 indicate the orientations of the magnetic moments (i.e., the magnetic orientation) of the magnetic material. For example, the arrows may indicate the orientation of the magnetic moment of the corresponding device from its south axis to its north axis. Though the orientations in the simplified example of FIG. 18A are all in the same plane, in other implementations the orientations may be in multiple planes. That is, the orientations of the magnetic moments may be along any combination of the x, y, and z directions rather than only in the x and y direction as depicted in FIG. 18A.

FIG. 18B illustrates uniform magnetic orientations of magnetic devices, in accordance with some exemplary implementations. As previously discussed in reference to FIG. 16, each of the devices 1805 have a relatively uniform magnetic orientation, and therefore, a strong magnetization may result from array 1800, which can attract other magnetic materials into the vicinity of or towards array 1800.

FIG. 18C illustrates alternating magnetic orientations of magnetic devices 1805, in accordance with some exemplary implementations. As previously discussed in reference to FIG. 17, having magnetic orientations in opposite directions may cancel out the quasi-static components and reduce the overall magnetization of array 1800 such that other magnetic materials may not be attracted into the vicinity of or towards array 1800.

The magnetic orientation of some magnetic material may be adjusted by heating the magnetic material and applying a magnetic field with the desired orientation. Based on the strength of the applied magnetic field and the temperature of the magnetic material, the magnetic orientation of the magnetic material may change to reflect the orientation of the applied magnetic field.

In particular, the Curie temperature (T_{C}), or Curie point, is the temperature at which magnetic material may be induced to change its magnetic moment orientation to that of the applied magnetic field. T_{C} may be based on the strength of the applied magnetic field. For example, the applied magnetic field may need to be stronger at a lower temperature than a higher temperature. As a result, heating a first subset of the devices 1805 within the array at or above T_{C} corresponding to the strength of the magnetic field while another subset of the devices 1805 within the array is below T_{C} may result in the first subset switching orientations while the second subset is unchanged. Accordingly, array 1800 in FIG. 18C with alternating magnetic orientations of magnetic devices may be implemented.

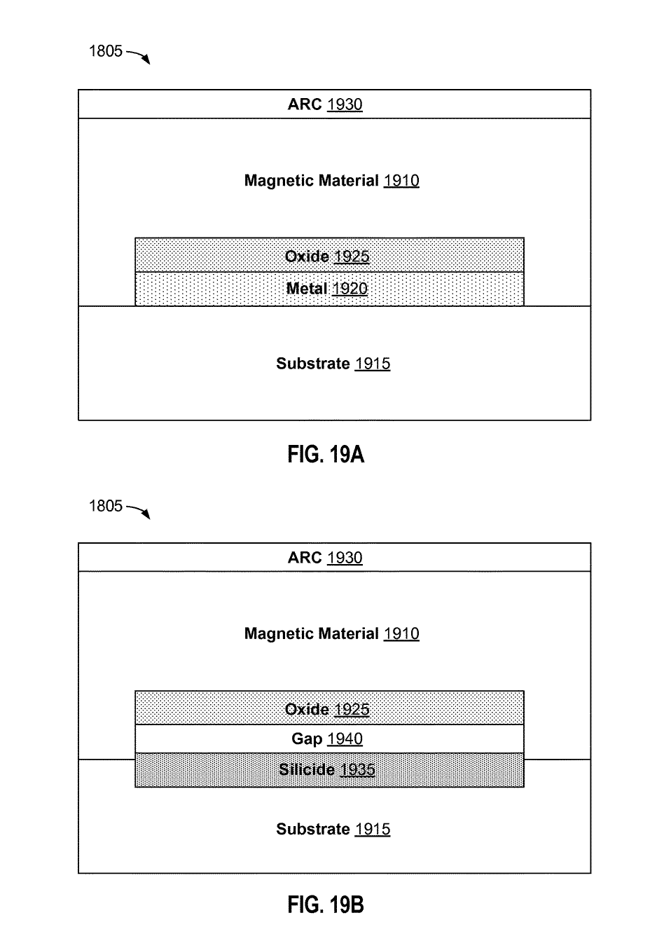

FIG. 19A illustrates a cross-section of a magnetic device 1805, in accordance with some implementations. Magnetic device 1805 in FIG. 19A is a structure with several portions, as discussed below. The magnetic device in FIG. 19A can form a thermal barrier when heated to retain heat within magnetic material layer 1910 so that T_{C} may be attained. Accordingly, the orientation of the magnetic moment of magnetic material layer 1910 may be adjusted by applying the appropriate magnetic field.

In more detail, in FIG. 19A, substrate 1915 may be a substrate upon which other layers may be placed or fabricated upon, for example, through physical vapor deposition, chemical vapor deposition, sputtering, or other techniques. Substrate 1915 may be a silicon substrate or amorphous silicon deposited on a glass or other type of substrate. Metal layer 1920 may be a metal layer adjacent to substrate 1915. For example, metal layer 1920 may be nickel. Oxide layer 1925 may be silicon dioxide (SiO₂) or other type of material that may be used as a barrier layer between magnetic material layer 1910 and metal layer 1920. Magnetic material layer 1910 may be a magnetic material such as NiFeB. ARC layer 1930 may be an anti-reflective coating (ARC) material. In some implementations, ARC layer 1930 may not be included in device 1805.

In the example of FIG. 19A, ARC layer 1930 may be used to absorb energy from a light source (or other type of radiation source that can provide energy) and generate heat that can thermally conduct to magnetic material layer 1910, oxide layer 1925, and metal layer 1920. As the temperature rises, metal layer 1920 may diffuse (or “sink”) into substrate 1915 (e.g., silicon) and form a silicide (e.g., a nickel silicide if metal layer 1920 in FIG. 19A is nickel). The diffusion of all or a part of metal layer 1920 into substrate 1915 may result in an air gap (or a vacuum gap) being formed from the volume formerly occupied by metal layer 1920. The air gap may be used as a thermal barrier to concentrate heat within magnetic material layer 1910.

FIG. 19B illustrates a cross-section of a magnetic device 1805 with a thermal barrier, in accordance with some exemplary implementations. In particular, FIG. 19B shows the structure of magnetic device 1805 in FIG. 19A after the absorption of the energy and formation of silicide from metal layer 1920 diffusing into substrate 1915 as described above. In FIG. 19B, silicide layer 1935 may be the result of metal layer 1920 in FIG. 19A diffusing into substrate 1915 and forming silicide layer 1935. As depicted in FIG. 19B, silicide layer 1935 may occupy a small portion of the volume formerly occupied by metal layer 1920 in FIG. 19A and include another portion within substrate 1915?. The volume of metal layer 1920 in FIG. 19A not occupied by the newly-formed silicide layer 1935 in FIG. 19B is air gap 1940 in FIG. 19B. That is, metal layer 1920 in FIG. 19A diffuses into substrate 1915 to form air gap 1940 and silicide layer 1935 in FIG. 19B.

Air gap 1940 may be used as a thermal barrier layer to reduce the radiation of heat from magnetic material layer 1910 to substrate 1915. In particular, air gap 1940 may have a low thermal conductivity (i.e., a lower thermal conductivity than metal layer 1820), and therefore, heat lost from magnetic material layer 1910 to substrate 1815 may be reduced.

For example, silicide layer 1935 and air gap 1940 may be formed between 280 and 340 degrees Celsius. As the light source (being used as a heat source to apply heat to and within device 1805) is still being applied to device 1805, the temperature of magnetic material 1910 may continue to rise due to air gap 1940 preventing heat loss from magnetic material layer 1910 to substrate 1915. Accordingly, the temperature of magnetic material layer 1910 may be able to reach T_{C} for a particular externally applied magnetic field. Moreover, T_{C} may be reached faster because heat is not lost from magnetic material 1910.

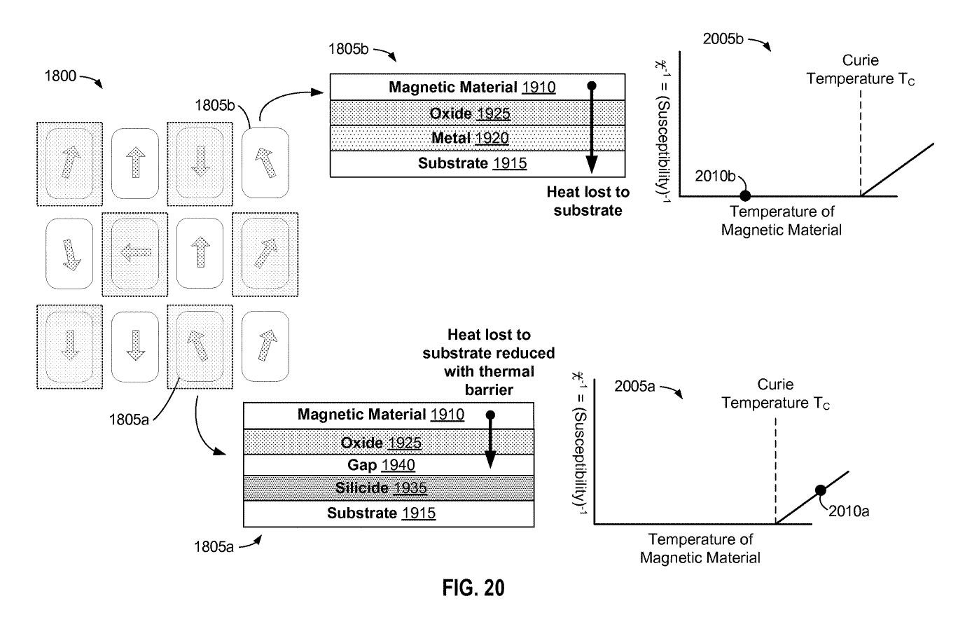

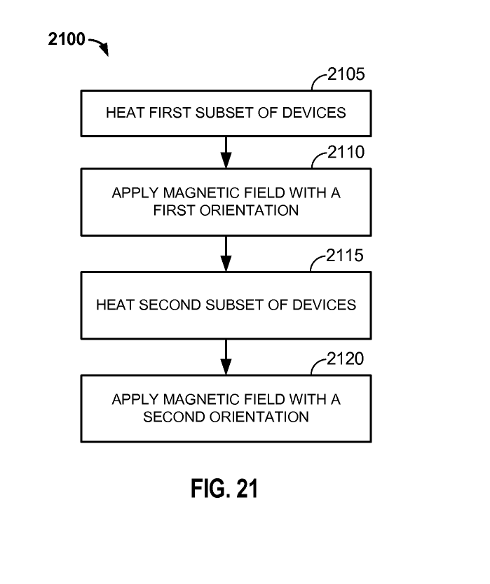

FIG. 20 illustrates adjusting magnetic orientations of different subsets of magnetic devices in an array, in accordance with some exemplary implementations. In FIG. 20, different subsets of devices 1805a and 1805b of array 1800 may be adjusted one at a time such that the overall magnetization of array 1800 may be reduced. A first subset of devices 1805a is indicated by the dotted lines and shading. The remaining devices 1805b of array 1800 in FIG. 20 are a second subset. The first and second subsets of devices 1805a and 1805b may be heated at different times and have their orientations adjusted to different orientations (e.g., opposing orientations).

For example, in FIG. 20, when the first subset of devices 1805 in array 1800 are heated (as indicated by the shading in FIG. 20), air gap 1940 may be formed, as indicated by device 1805a. However, in device 1805b (indicated as not being shaded in FIG. 20) in the second subset of devices 1805 in array 1800, air gap 1940 may not be formed because the temperature of the second subset of devices may not reach the required temperature to form silicide layer 1935 and air gap 1940. That is, the thermal barrier may not be formed, and therefore, device 1805b may have a lower temperature than device 1805a due to heat from magnetic material layer 1910 of device 1805b being lost to substrate 1915.

If an external magnetic field is applied to array 1800 and the temperature of device 1805a (and the other devices within its subset) is at or above the Curie temperature T_{C} corresponding to the strength of the external magnetic field and the temperature of device 1805b (and the other devices within its subset) is below T_{C}, then the magnetic orientations of the first subset of devices 1805a may be adjusted to match, or be similar to, the orientation of the externally applied magnetic field. However, the magnetic orientations of the second subset 1805b may remain unchanged. That is, the second subset 1805b may not react to the external magnetic field because it has not reached T_{C} corresponding to the strength of the external magnetic field applied to array 1800.

For example, in FIG. 20, charts 2005a and 2005b show a temperature dependence of the reciprocal of the magnetic susceptibility of ferromagnets (such as NiFeB) above the Curie temperature T_{C} (indicated by the dotted line meeting the x-axis) following the Curie-Weiss law. The magnetization of the magnetic material becomes responsive to the externally applied magnetic field approximately about the Curie temperature T_{C}, as previously discussed (i.e., the magnetic material can be “programmed” by the externally applied magnetic field) for a particular strength of the externally applied magnetic field. In chart 2005a, point 2010a may be the temperature at which device 1805a is heated at using the previous example at a first time. In chart 2005b, point 2010b may be the temperature at which device 1805b is heated at during that first time. The temperature of device 1805a is higher than the temperature of device 1805b because the energy source (e.g., light source) is focused on devices 1805a rather than devices 1805b and air gap 1940 has been formed in devices 1805a, reducing the heat loss from magnetic material 1910 to substrate 1915. Accordingly, devices 1805a may be re-oriented by an externally applied magnetic field while devices 1805b may not be re-oriented because devices 1805a are more susceptible to the external magnetic field applied to array 1800 while devices 1805b are not (i.e., it does not react to the external magnetic field). Afterwards, devices 1805b may be subject to the energy source at a second time after the first time such that point 2010b reaches or exceeds Tc in chart 2005b with the formation of air gaps and the orientation of the externally applied magnetic field can be switched to the desired magnetic orientation for the magnetic material 1920 of devices 1805b. For example, the magnetic orientation for devices 1805b may be in the opposite (or opposed) direction or orientation as the magnetic orientation of devices 1805a.

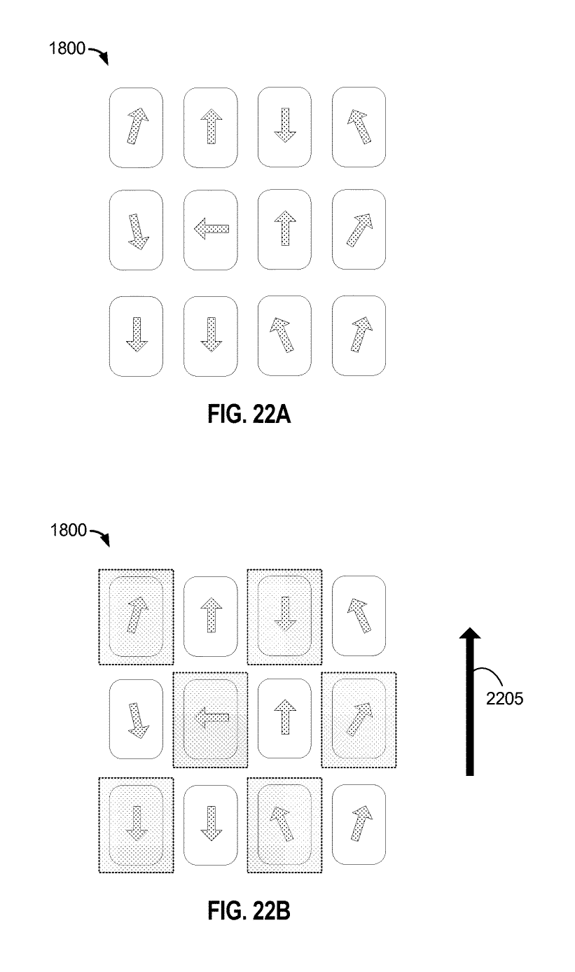

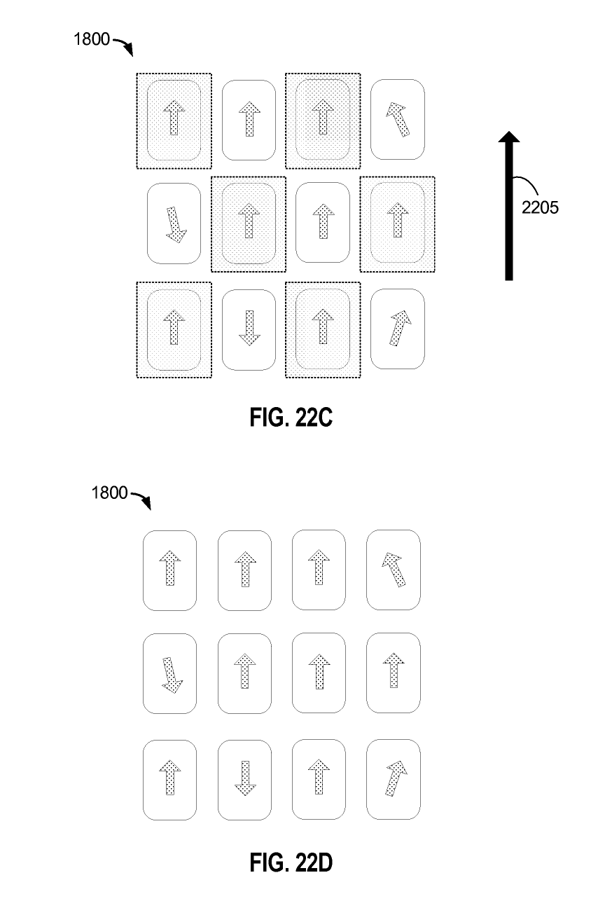

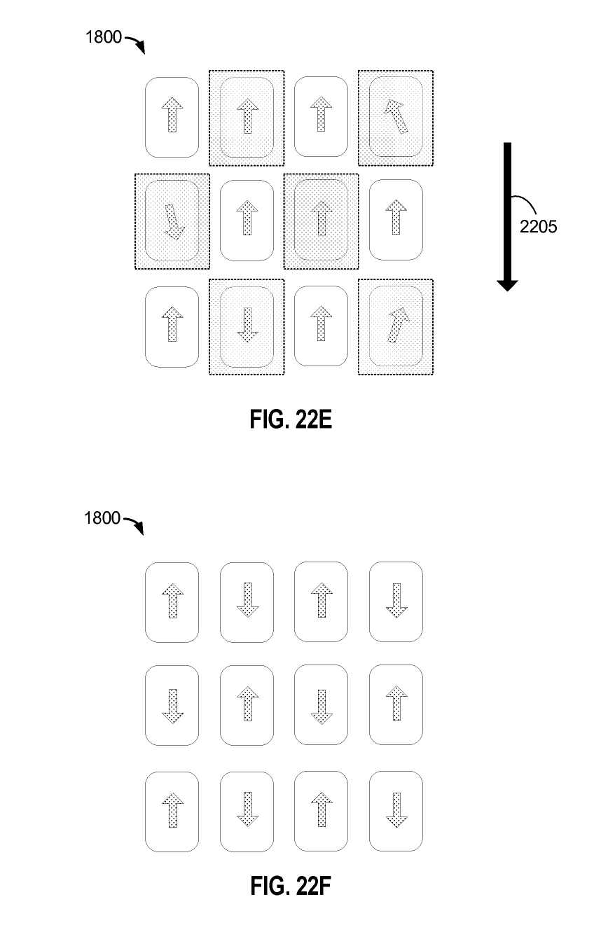

In some implementations, the subsets of devices 1805 of array 1800 may be heated one subset at a time and the magnetic orientations may be adjusted one subset at a time. FIG. 21 is a flowchart of a method of adjusting magnetic orientations of different subsets of magnetic devices in an array, in accordance with some exemplary implementations. FIGS. 22A-F illustrate adjusting magnetic orientations of different subsets of magnetic devices in an array, in accordance with some exemplary implementations.

In method 2100 of FIG. 21, at block 2105, a first set of devices may be heated. For example, an array 1800 of devices with magnetic material as depicted in FIG. 22A may have non-uniform magnetic orientations. As depicted in FIG. 22B, a subset of the devices in the array 1800 (as indicated by the dotted lines and shading) may be heated, for example, with an optical light source (e.g., a laser) or other type heat source. Accordingly, thermal barriers (e.g., an air gap), as depicted in device 1805a of FIG. 20 or device 1805 in FIG. 19) may be formed to reduce the dissipation of heat from the magnetic material to the substrate. At block 2110, a magnetic field with a first orientation can be applied. For example, as depicted in FIG. 22B, magnetic field 2205 with a first orientation (as indicated by the direction of the arrow) can be applied to array 1800. In FIG. 22C, the first subset of devices may have their magnetic orientations match that of magnetic field 2205 when they reach or exceed the Curie temperature. At block 2115, a second subset of devices of the array 1800 may be heated. For example, after the first subset of devices have been heated and had their magnetic orientations adjusted, the temperature of the first subset of devices may be reduced from the Curie temperature (e.g., by turning off the heat source and waiting for the devices to cool) and magnetic field 2205 may be turned off. Accordingly, array 1800 as depicted in FIG. 22D may be formed, with the first subset of devices having a uniform orientation, but the second subset of devices still with non-uniform orientations. Accordingly, as depicted in FIG. 22E, the second subset of devices of array 1800 may be heated and magnetic field 2205 may be applied, but in another orientation from the first orientation (e.g., an opposing or opposite orientation, or direction) used when the first subset of devices were being heated. As a result, array 1800 as depicted in FIG. 22F may be implemented by adjusting the magnetic orientations.

In some implementations, method 2100 may be performed by fabrication equipment. For example, equipment to illuminate selected subsets of devices with radiation (e.g., light) that can be readily absorbed and a magnetization apparatus to apply a sufficiently large magnetic field across the magnetic material to magnetize the magnetic material of the selected subsets that have been heated above the Curie temperature can be used. The illumination apparatus may be a laser-based system using mirror scanners and shutters or a spatial light modulator to impose the illumination pattern.

Additionally, before, after, or in between the blocks of method 2100, further processes may be performed to configure or manufacture structures capable of oscillating in the presence of an externally generated alternating magnetic field. For example, the magnetic material may be part of magneto-mechanical oscillator structures such as cantilevers, torsional plates, etc. in which movement in one or more directions is allowed in response to the magnetic material interacting with the externally generated alternating magnetic field. Accordingly, a cavity or free space may be etched to allow for movement of the magnetic material.

In some implementations, the magneto-mechanical oscillators may be implemented in an array for a receiver of a wireless power system. For example, the externally generated alternating magnetic field can be generated by a transmitter and the magneto-mechanical oscillators of the receiver can oscillate in response to the externally generated alternating magnetic field to generate electrical energy used to power a load. Accordingly, the magnet material can be a part of a corresponding structure implementing a resonant mechanical oscillator that can oscillate at a frequency of an externally generated magnetic field provided by the transmitter.

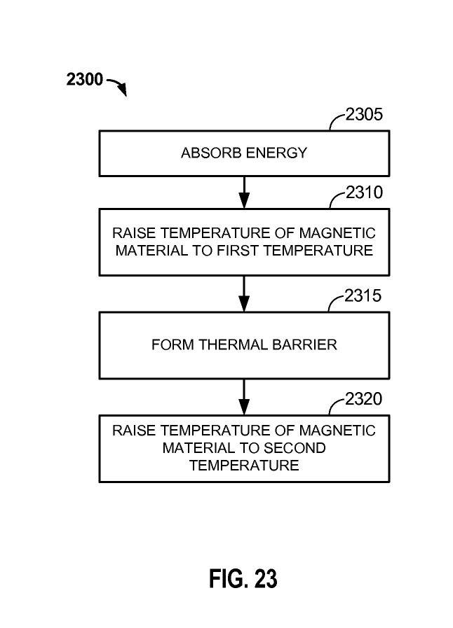

FIG. 23 is a flowchart of a method of forming a thermal barrier in a magnetic device, in accordance with some exemplary implementations. In method 2300, at block 2305, energy may be absorbed by a magnetic device. For example, a light source may be applied to magnetic device 1805 in FIG. 19A such that heat may be generated. In some implementations, the energy from the light source may be absorbed by ARC layer 1930 in FIG. 19A and magnetic material 1910 may increase in temperature. At block 2310, the temperature of the magnetic material may be raised to a first temperature. Accordingly, at block 2315, a thermal barrier may be formed within the magnetic device. For example, air gap 1940 in FIG. 19B may be formed by metal layer 1920 in FIG. 19A diffusing into substrate 1915 (e.g., a silicon substrate or amorphous silicon deposited upon the substrate) to create silicide layer 1935 in FIG. 19B. Air gap 1940 in FIG. 19B may be used as a thermal barrier to reduce the loss of heat from magnetic material 1910 to substrate 1915. As a result, at block 2320, the temperature of the magnetic material may rise to a second temperature at or exceeding the Curie temperature T_{C}.

In some implementations, multiple subsets of the devices of array 1800 may be adjusted to have different magnetic orientations. For example, four different orientations may be implemented. Moreover, any pattern of devices with different magnetic orientations may be implemented. For example, a checkerboard pattern as depicted in the examples disclosed above may be implemented, but alternating orientations may be implemented in rows, columns, halves of array 1800, or other groupings.

In some implementations, when the first subset of devices is heated, the second subset of devices may be covered with a photoresist mask layer or a metal mask layer such that the devices may not be heated (or not heated as much due to the mask layer reducing the amount of heat that conducts to the magnetic material) while the devices in the first subset are heated without being covered with a photoresist mask layer or a metal mask layer.

In certain implementations, the wirelessly transferred power is used for wirelessly charging an electronic device (e.g., wirelessly charging a mobile electronic device). In certain implementations, the wirelessly transferred power is used for wirelessly charging an energy-storage device (e.g., a battery) configured to power an electric device (e.g., an electric vehicle).

The various operations of methods described above may be performed by any suitable means capable of performing the operations, such as various hardware and/or software component(s), circuits, and/or module(s). Generally, any operations illustrated in the figures may be performed by corresponding functional means capable of performing the operations. For example, a power transmitter or receiver can comprise means for generating a second time-varying magnetic field having an excitation frequency by applying a first time-varying magnetic field having the excitation frequency to the means for generating the second time-varying magnetic field. The means for generating the second time-varying magnetic field can comprise a plurality of magneto-mechanical oscillators in which each magneto-mechanical oscillator of the plurality of magneto-mechanical oscillators has a mechanical resonant frequency substantially equal to the excitation frequency and is configured to generate the second magnetic field via movement of the oscillators under the influence of the first magnetic field.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the implementations of the invention.

The various illustrative blocks, modules, and circuits described in connection with the implementations disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the implementations disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer readable media. The processor and the storage medium may reside in an ASIC.

For purposes of summarizing the disclosure, certain aspects, advantages and novel features of the inventions have been described herein. It is to be understood that not necessarily all such advantages may be achieved in accordance with any particular implementation of the invention. Thus, the invention may be embodied or carried out in a manner that achieves or optimizes one advantage or group of advantages as taught herein without necessarily achieving other advantages as may be taught or suggested herein.

Various modifications of the above described implementations will be readily apparent, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. A method for adjusting magnetic orientations of different sets of magnets in an array, the array including a first set of magnets and a second set of magnets, the method comprising:
heating the first set of magnets in the array;
applying a first magnetic field with a first orientation to the array of magnets;
adjusting the magnetic orientations of the first set of magnets in the array to correspond with the first orientation of the first magnetic field based on the heating of the first set of magnets and the applied first magnetic field with the first orientation;
heating the second set of magnets in the array;
applying a second magnetic field with a second orientation to the array of magnets; and
adjusting the magnetic orientations of the second set of magnets in the array to correspond with the second orientation of the second magnetic field based on the heating of the second set of magnets in the array and the applied second magnetic field with the second orientation.

2. The method of claim 1, wherein heating the first set of magnets heats magnetic material of the first set of magnets to a first temperature range, magnetic material of the second set of magnets being at a second temperature range, the first temperature range corresponding to temperatures at or above a curie temperature of the magnetic material of the first set of magnets, the second temperature range corresponding to temperatures below the curie temperature of the magnetic material of the second set of magnets.

3. The method of claim 2, wherein the curie temperature corresponds to a temperature in which the magnetic material of the first set of magnets is susceptible to be oriented in a direction of the first magnetic field with the first orientation in response to applying the first magnetic field.

4. The method of claim 3, wherein the magnetic material of the second set of magnets are not susceptible be oriented in the direction of the first magnetic field in response to applying the first magnetic field with the first orientation.

5. The method of claim 1, wherein applying the first magnetic field with the first orientation comprises having a magnetic field strength of the first magnetic field capable of adjusting the magnetic orientations of magnetic material of the first set of the magnets with the first orientation, and incapable of adjusting the magnetic orientations of magnetic material of the second set of magnets with the first orientation.

6. The method of claim 1, wherein the first orientation and the second orientation are different.

7. The method of claim 1, wherein heating the first set of magnets forms thermal barriers in the first set of magnets.

8. The method of claim 7, wherein the thermal barriers allow the first set of magnets to reach or exceed a curie temperature of magnetic material of the first set of magnets.

9. The method of claim 7, wherein the thermal barriers are air gaps.

10. The method of claim 1, further comprising:
etching free spaces to allow for the magnets in the array to oscillate into the free spaces.

11. The method of claim 1, wherein each of the magnets is part of a corresponding structure implementing a resonant mechanical oscillator configured to oscillate at a frequency of an externally generated magnetic field.

12. An array of magnets on a substrate, each of the magnets comprising:
a silicide layer having a portion within the substrate;
a thermal barrier layer adjacent to the silicide layer;
an oxide layer adjacent to the thermal barrier layer opposite the silicide layer; and
a magnetic material layer adjacent to the oxide layer opposite the thermal barrier layer.

13. The array of magnets of claim 12, wherein the array includes a first magnet and a second magnet, the first magnet having the magnetic material corresponding to a first magnetic orientation, the second magnet having the magnetic material corresponding to a second magnetic orientation, the first magnetic orientation and the second magnetic orientation being different.

14. The array of magnets of claim 13, wherein the orientations of the first magnetic orientation and the second magnetic orientation are different.

15. The array of magnets of claim 12, each of the magnets further comprising:
an anti-reflective coating (ARC) layer deposited on the magnetic material layer.

16. The array of magnets of claim 12, wherein the thermal barrier layer is an air gap.

17. A method for forming a thermal barrier in a magnetic device, the method comprising:
absorbing energy from an energy source;
raising a temperature of magnetic material of the magnetic device to a first temperature responsive to the absorbing of the energy;
forming a thermal barrier in the magnetic device responsive to the magnetic material being raised to the first temperature; and
raising the temperature of the magnetic material of the magnetic device to a second temperature responsive to the forming of the thermal barrier.

18. The method of claim 17, wherein the second temperature is higher than the first temperature.

19. The method of claim 17, wherein the thermal barrier is an air gap.

20. The method of claim 19, wherein forming the thermal barrier comprises forming a silicide layer into a substrate from a diffusion of a metal layer deposited upon the substrate.

21. The method of claim 20, wherein the thermal barriers are air gaps formed between an oxide layer and the silicide layer.

22. The method of claim 20, wherein silicide layer is formed responsive to raising the temperature of the magnetic material of the magnetic device to the first temperature.

23. The method of claim 17, wherein the second temperature is at or exceeds a curie temperature of the magnetic material.

24. An array of magnets on a substrate, each of the magnets comprising:
means for absorbing energy to raise a temperature of magnetic material of the magnet to a first temperature;
means for providing a thermal barrier in the magnet responsive to the magnetic material being raised to the first temperature; and
means for absorbing energy to raise the temperature of the magnetic material of the magnet to a second temperature responsive to the providing of the thermal barrier.
